(19) United States
(12) Patent Application Publication
(10) Pub. No.: US 2012/0248149 A1
(43) Pub. Date: Oct. 4, 2012

(54) LIQUID DISPENSER

(75) Inventor: Keith Pelfrey, Wadsworth, OH (US)

(73) Assignee: GOJO INDUSTRIES, INC., Akron, OH (US)

(21) Appl. No.: 13/075,457

(22) Filed: Mar. 30, 2011

(51) Int. Cl. B05B 7/26; B67D 7/66; B23P 11/00; B67D 7/76

(52) U.S. Cl. 222/214; 222/189.1; 29/428

(57) ABSTRACT

A liquid dispenser is disclosed in the present application. In one exemplary embodiment, a liquid dispenser is configured to dispense foam. The liquid dispenser includes a frame portion, a pump portion, a refill portion, and a guide portion. The pump portion includes one or more compression members coupled to a rotatable member. The rotatable member is configured to rotate relative to the frame portion. The refill portion includes a liquid container, a tube, and a foaming nozzle. The tube is fluidly coupled to the liquid container and the foaming nozzle. The tube is positioned between the compression members and the guide portion. The tube is compressed by the one or more compression members as the rotatable member rotates to move liquid material from the liquid container to the foaming nozzle. The foaming nozzle is configured to covert the liquid material to foam, which is dispensed by the liquid dispenser.

### TECHNICAL FIELD

The present application generally relates to a dispenser for dispensing liquid material, such as liquid soap. In one particular embodiment, a dispenser of the present application includes a peristaltic pump and dispenses liquid material as foam.

### BACKGROUND

Liquid dispensers are generally configured to provide a user with an amount of liquid material upon actuation of the dispenser. Some liquid dispensers are configured to dispense the liquid material as foam. These foam dispensers generally convert the liquid material, such as liquid soap, into foam by aerating the liquid material as it is dispensed. Air is generally injected into the liquid material to form air bubbles in the liquid, causing the formation of foam. Many of these foam dispensers do not produce a continuous stream of foam, but rather produce a limited amount of foam over a short duration of time. Liquid dispensers also may include a refill container that is replaced after the liquid material therein is consumed by the user. Liquid dispensers with high usage rates generally require frequent and rapid replacement of the refill container.

### SUMMARY

A liquid dispenser, a refill unit for a liquid dispenser, and methods for refilling a liquid dispenser are disclosed in the present application. In one exemplary embodiment, a liquid dispenser is configured to dispense foam. The liquid dispenser includes a frame portion, a pump portion, a refill portion, and a guide portion. The pump portion includes one or more compression members coupled to a rotatable member. The rotatable member is configured to rotate relative to the frame portion. The refill portion includes a liquid container, a tube, and a foaming nozzle. The first end of the tube is fluidly coupled to the liquid container and the second end of the tube is fluidly coupled to the foaming nozzle. The guide portion is movably coupled to the frame portion. The tube of the refill portion is positioned between at least one compression member and the guide portion. The tube is compressed by the one or more compression members as the rotatable member rotates relative to the frame portion to move liquid material from the liquid container to the foaming nozzle. The foaming nozzle is configured to covert the liquid material to foam, which is dispensed by the liquid dispenser.

In another exemplary embodiment, a refill unit for a foam dispenser is disclosed. The refill unit includes a liquid container configured to hold a liquid material, a tube, and a foaming nozzle. A first end of the tube is fluidly coupled to the liquid container and a second of the tube is fluidly coupled to the foaming nozzle. The foaming nozzle is configured to convert the liquid material to a mist of liquid material. The mist of liquid material is mixed with air within the foaming nozzle to form a mixture. The mixture is passed through a screen of the foaming nozzle to form a foam.

In another exemplary embodiment, a method for replacing a refill unit of a liquid dispenser is disclosed. The method includes moving a guide portion of the liquid dispenser away from at least one compression member of a pump portion of the liquid dispenser. A first tube of a first refill unit is removed from between the guide portion and the at least one compression member. A second tube of a second refill unit is positioned between the guide portion and the at least one compression member. The guide portion of the liquid dispenser is moved toward the at least one compression member of the pump portion of the liquid dispenser. The guide portion is locked relative to the at least one compression member such that at least a portion of the second tube is pinched between the guide portion and the at least one compression member.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of the inventions.

FIG. 1 illustrates a liquid dispenser according to an embodiment of the present application.

FIG. 2 illustrates a liquid dispenser according to an embodiment of the present application.

FIG. 3 is a perspective view of a liquid dispenser according to an embodiment of the present application.

FIG. 4 is a partially exploded view of the liquid dispenser of FIG. 3 showing a guide, refill container, outlet tube, and foaming nozzle removed from the dispenser according to an embodiment of the present application.

FIG. 5 is an exploded view of a drive assembly of the liquid dispenser of FIG. 3 according to an embodiment of the present application.

FIG. 6 is a perspective view of the liquid dispenser of FIG. 3 showing a guide in a locked position according to an embodiment of the present application.

FIG. 7 is a perspective view of the liquid dispenser of FIG. 3 showing a guide in an unlocked position according to an embodiment of the present application.

FIG. 8 is a rear elevational view of a guide, an outlet tube, engagement members, and a foaming nozzle of the liquid dispenser of FIG. 3 according to an embodiment of the present application.

FIGS. 9A-9C are front perspective, rear perspective, front elevational, and rear elevational views, respectively, of a guide of the liquid dispenser of FIG. 3 according to an embodiment of the present application.

FIG. 10 is a rear elevational view of a liquid dispenser according to an embodiment of the present application.

FIG. 11 is a perspective view of the liquid dispenser of FIG. 10.

FIG. 12 is a perspective view of an outlet tube, a foaming nozzle, a peristaltic pump, and a refill container of the liquid dispenser of FIG. 10 according to an embodiment of the present application.

FIG. 13 is an elevational view of a coupling of an outlet tube of the liquid dispenser of FIG. 10 according to an embodiment of the present application.

FIG. 14 is an exploded view of a drive assembly of the liquid dispenser of FIG. 10 according to an embodiment of the present application.

FIG. 15 is a partially exploded view of a peristaltic pump of the liquid dispenser of FIG. 10 according to an embodiment of the present application.

FIGS. 16 and 17 are perspective views of a peristaltic pump of the liquid dispenser of FIG. 10 according to an embodiment of the present application.

FIGS. 18A and 18B are front and rear perspective views, respectively, of a peristaltic pump of the liquid dispenser of FIG. 10 having a closed cover according to an embodiment of the present application.

FIG. 19 is a partially exploded perspective view of a cam lock pivotably coupled to a mounting plate according to an embodiment of the present application.

FIGS. 20A and 20B are front and rear perspective views, respectively, of a cam lock pivotably coupled to a mounting plate according to an embodiment of the present application.

FIGS. 21A-21C are perspective, side elevational, and exploded perspective views, respectively, of a foaming nozzle according to an embodiment of the present application.

FIG. 22 is a cross sectional side view of the foaming nozzle of FIGS. 21A-21C.

FIGS. 23A-23B are rear and front elevational views, respectively, of the foaming nozzle of FIGS. 21A-21C.

FIG. 24 is a cross sectional perspective view of a housing portion and a foaming chip portion of a foaming nozzle according to an embodiment of the present application.

FIG. 25 is a cross sectional perspective view of a foaming spout of a foaming nozzle according to an embodiment of the present application.

FIG. 26A illustrates a liquid dispenser with a pressure plate or guide in the load position according to an embodiment of the present application.

FIG. 26B illustrates a liquid dispenser with a liquid pump in the load position according to an embodiment of the present application.

### DESCRIPTION OF EMBODIMENTS

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements.

The liquid dispenser of the present application generally includes a refill portion and a pump portion. The refill portion of the liquid dispenser generally includes a liquid container and a tube in fluid communication with the liquid container. The pump portion of the liquid dispenser engages the tube to move liquid material from the liquid container, through the tube, and out a nozzle of the dispenser.

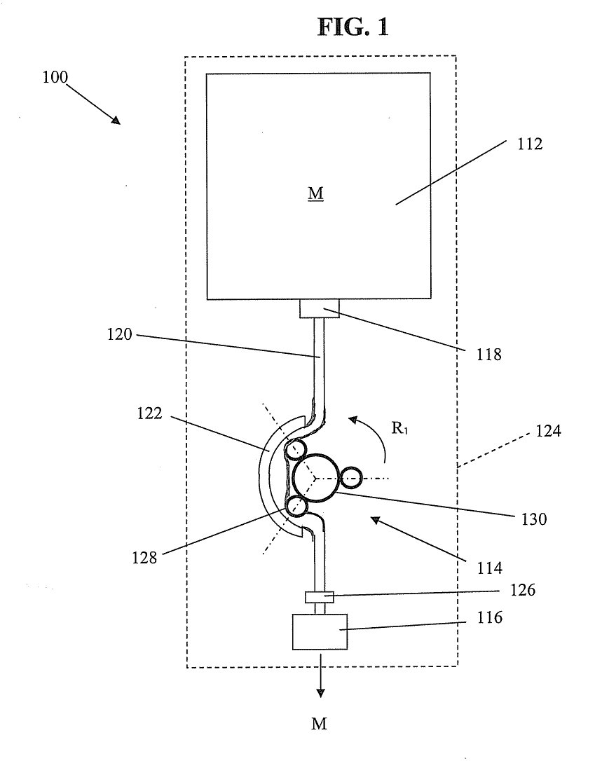

FIG. 1 illustrates a liquid dispenser 100 according to one embodiment of the present application. As illustrated, the liquid dispenser 100 includes a refill unit and a liquid pump 114. The refill unit of the liquid dispenser 100 includes a liquid container 112 having an outlet 118, a tube 120, a valve 126, and a nozzle 116. The liquid dispenser 100 is configured such that it may be encased in a housing 124.

As illustrated in FIG. 1, the liquid pump 114 of the liquid dispenser 100 is a peristaltic pump having a rotor 130 with three compression members 128 coupled thereto and equally spaced about a circumference of the rotor, or about 120 degrees apart. The rotor 130 is configured to rotate in a direction R₁ (counter clockwise) such that the compression members 128 compress the tube 120 to move liquid material M from the liquid container 112, through the tube, through the valve 126, and out the nozzle 116 of the refill unit. As illustrated in FIG. 1, the compression members 128 include rollers configured to rotate relative to the rotor 130 such that the compression members roll across the outer surface of the tube 120 as the tube is compressed.

The rotor 130 and the compression members 128 may be rotated by various means. For example, a motor (e.g., an electric motor) may be used to rotate the rotor 130 and/or the compression members 128. Further, the rotor 130 and/or compression members 128 may be rotated manually, such as with a crank or lever. In other embodiments, more or less compression members may be used in various configurations or arrangements. For example, the compression members may or may not be equally spaced about a circumference of the rotor. Further, one or more compression members may not be configured to rotate relative to the rotor and instead slide across the outer surface of the tube as the tube is compressed. Other shapes and configurations of compression members may also be used, such as shoes, cams, wipers, or the like.

The liquid dispenser 100 also includes a pressure plate or guide 122. As illustrated in FIG. 1, the tube 120 is positioned between the compression members 128 and the pressure plate 122. The pressure plate 122 is locked or otherwise held stationary as the rotor 130 rotates such that the tube 120 may be compressed by the compression members 128 (i.e., the tube is pinched between the pressure plate and the compression members as the rotor turns). For example, as the rotor 130 rotates in the direction R₁, the portion of the tube 120 under compression (i.e., the portion of the tube between the compression members 128 and the pressure plate 122) closes or occludes to force the liquid material M to be pumped or moved through the tube and toward the nozzle 116. Once the compression members 128 pass over the portion of the tube 120, the tube opens to its natural state to induce the flow of liquid material M from the liquid container 112 to the liquid pump 114 (i.e., the opening of the tube creates a vacuum that draws liquid material from the liquid container into the tube).

The liquid pump 114 of the liquid dispenser 100 is configured to provide a continuous stream of the liquid material M from the liquid container 112 to the nozzle 116 with a minimal amount of energy. The rotation of the liquid pump 114 permits the pressure of the liquid material M to build quickly at the valve 126. Once the valve 126 opens, the continual rotation of the liquid pump 114 delivers a continuous stream of the liquid material M to the nozzle 116.

The liquid pump 114 may also be configured to “suck back” the liquid material M delivered to the nozzle 116 such that excess liquid material in the nozzle is prohibited from dripping out when the liquid dispenser 100 is not in use. For example, once a user of the liquid dispenser 100 has received a sufficient amount of the liquid material M from the nozzle 116, the direction of rotation of the rotor 130 and compression members 128 may reverse, or rotate clockwise, to draw any remaining liquid material in the nozzle 116 back up into the tube 120. This reversal in direction of the compression members 128 permits the portion of the tube 120 below the compression members to open, creating a vacuum that draws the liquid material M from the nozzle 116 back into the tube 120. The valve 126 may be configured to open and permit the liquid material M to flow from the nozzle 116 back into the tube 120 when the rotation of the liquid pump 114 is reversed, e.g., a two-way valve. The liquid dispenser 100 may also be configured without the valve 126, instead relying on the compression members 128 (i.e. the rollers) to prohibit dripping or back flow.

As illustrated in FIG. 1, the tube 120 of the refill unit is pinched between the pressure plate 122 and the compression members 128 when the liquid dispenser 100 is in the use position. To facilitate loading of the refill unit of the liquid dispenser 100, one or both of the pressure plate 122 and the liquid pump 114 may be configured to be moveable between a load position and the use position illustrated in FIG. 1.

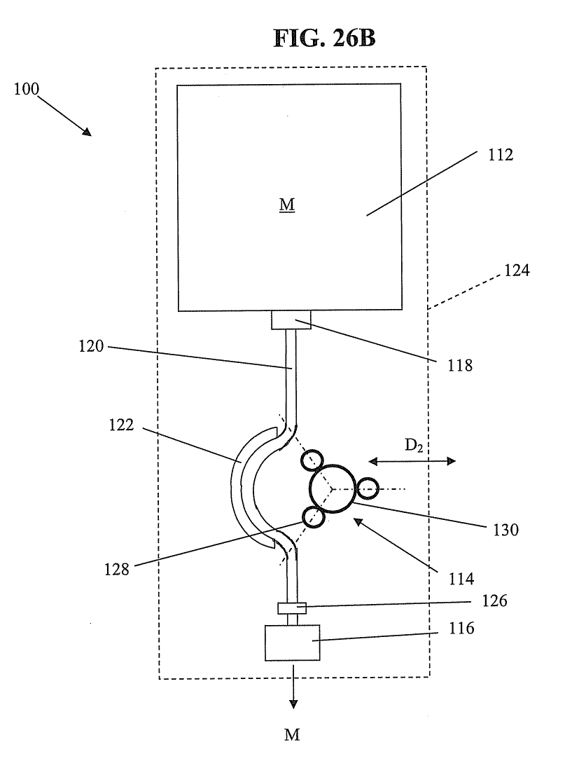

For example, the pressure plate 122 may be configured to be retracted, pivoted, or otherwise moved away from the compression members 128 to a load position that permits the tube 120 to be positioned between the pressure plate and the compression members. In one embodiment illustrated in FIG. 26A, the pressure plate 122 is moved horizontally in a direction D₁ away from the compression members 128 to a load position. However, in other embodiments, the pressure plate 122 is pivoted relative to the compression members 128, or otherwise moved away from the compression members, to permit the tube 120 to be positioned between the pressure plate and, the compression members. The pressure plate 122 may then be moved from the load position to the use position and locked or otherwise fixed relative to the compression members 128 such as to clamp or pinch the tube 120 between the pressure plate and the compression members. Optionally, the pressure plate 122 may also include a biasing member, such as a spring or an elastomeric element, that biases the pressure plate toward the use position, which may be used alone or in combination with a locking mechanism. The pressure plate 122 may also include a guide for the tube 120, such as a groove or notch, that is at least accessible when the pressure plate is in the load position. The tube 120 may be placed in the guide of the pressure plate 122 in the load position and moved along with the pressure plate to the use position.

As another example, the liquid pump 114 may be configured to be retracted, pivoted, or otherwise moved away from the pressure plate 122 to a load position that permits the tube 120 to be positioned between the pressure plate and the compression members 128. In one embodiment illustrated in FIG. 26B, the liquid pump 114 is moved horizontally in a direction D₂ away from the pressure plate 122 to a load position. However, in other embodiments, the liquid pump 114 is pivoted relative to the pressure plate 122, or otherwise moved away from the pressure plate, to permit the tube 120 to be positioned between the pressure plate and the compression members 128. The liquid pump 114 may then be moved from the load position to the use position and locked or otherwise fixed relative to the pressure plate 122 such as to clamp or pinch the tube 120 between the pressure plate and the compression members 128. Optionally, the liquid pump 114 may also include a biasing member, such as a spring or an elastomeric element, that biases the liquid pump toward the use position, which may be used alone or in combination with a locking mechanism. To facilitate loading of the refill unit, the pressure plate 122 may include a guide for the tube 120 that is at least accessible when the liquid pump 114 is in the load position.

The liquid container 112 of the liquid dispenser 100 may take a variety of shapes, forms, or configurations capable holding a liquid material, such as liquid soap, foamable liquid, liquid sanitizer, or the like. For example, the liquid container 112 may be a bag, a pouch, a gusseted bag or pouch, a bottle, or the like. The liquid container 112 may be flexible or rigid, and may be made from a variety of materials known in the industry. The outlet 118 of the liquid container 112 may be integrally formed with the container or may be a separate component that is attached or otherwise coupled to the container. The outlet 118 of the liquid container 112 may also include a member that pierces at least a portion of the liquid container 112 to permit fluid communication between the liquid container and the tube 120. As such, at least a portion of the liquid container 112 may be made of a pierceable material, such as a membrane polymer, foil, or other materials known in the industry.

Various devices or methods may be used to prohibit usage of a wrong, unintended, or otherwise improper liquid container or refill unit with the liquid dispenser 100. These devices or methods may be mechanical, electrical, and/or chemical in nature. One example of such device or method is keying the liquid container or refill unit with a body portion of the liquid dispenser 100. A first portion of the key may be attached to the liquid container or refill unit. The first portion of the key being configured to mate with a second portion of the key that may be attached to the body portion of the liquid dispenser 100.

As illustrated in FIG. 1, the tube 120 of the liquid dispenser 100 is coupled to the outlet 118 of the liquid container 112 at one end and the valve 126 at the other end. The tube 120 is flexible such that it may be compressed by the compression members 128 and resilient such that it may quickly return to its natural shape after being compressed. The tube 120 may be made from a variety of flexible, resilient materials and in a variety of sizes. For example, the tube 120 may be made from a thermoset or thermoplastic elastomer, or any combination thereof, between about 0.1 inch and about 1 inch in diameter and having a wall thickness between about 0.01 inch and about 0.4 inch. However, other types of materials may be used. Further, the tube 120 may be a variety of other shapes and sizes.

As illustrated in FIG. 1, the nozzle 116 of the refill unit is a foaming nozzle or tip that converts the liquid material M to foam prior to being dispensed. The liquid pump 114 of the liquid dispenser 100 is configured to deliver the liquid material M to the nozzle 116 at a pressure sufficient to permit conversion of the liquid material to foam. For example, in one exemplary embodiment, the liquid pump 114 delivers the liquid material M to the nozzle 116 at a pressure between about 4 and 40 psi. However, the liquid pump 114 may be configured to deliver the liquid material M at any pressure that permits conversion of the liquid material to foam.

Further, the valve 126 may be configured to permit the pressure of the liquid material M from the liquid pump 114 to build before the valve opens and the liquid material is delivered to the nozzle 116. For example, in one exemplary embodiment, the valve 126 is a check valve configured to permit the pressure of liquid material M to build, before the valve opens and the liquid material is delivered to the nozzle 116. However, other types and configurations of valves may also be used. The nozzle 116 and the valve 126 may be included in a common structure made of one or more components that is fluidly coupled to the tube 120.

In one exemplary embodiment, the nozzle 116 converts the liquid material M to foam by accelerating the pressurized liquid material from the liquid pump 114 and forcing the liquid material through an orifice. For example, the nozzle 116 may be configured such that the pressurized liquid material M is forced through openings that restrict the flow the liquid material and increase the velocity of the liquid material to a velocity of about 1 m/s. Further, the nozzle 116 may be configured such that the liquid material spins or rotates within the nozzle to accelerate the liquid material. The accelerated liquid material M may then be forced through an orifice (e.g., an atomizer nozzle) in the nozzle 116 having a diameter between about 0.005 inch and about 0.06 inch. When the liquid material M passes through the orifice, a vacuum is created within the nozzle 116 that draws in air. The air mixes with the liquid material M in the nozzle 116 to form a pre-foam mixture. The pre-foam mixture then passes through a screen to create a foam. However, in one embodiment, the liquid material M is dispensed as a liquid spray and not a foam.

In another exemplary embodiment of the nozzle 116, the pressurized liquid material M from the liquid pump 114 is mixed with pressurized air from an air pump (not shown). The mixing of the liquid material M and the air forms air bubbles in the liquid material, causing the formation of a foam. However, it should be understood that the liquid dispenser 100 need not be limited to use with a foaming nozzle. In some embodiments, the nozzle 116 of the refill unit may be an outlet of the tube 120 and does not convert the liquid material M to foam prior to being dispensed.

The refill unit of the liquid dispenser 100 is configured to be replaceable. Once the liquid material M in the liquid container 112 is consumed, the refill unit may be removed from the liquid dispenser 100 and replaced with a another refill unit with minimal effort. The liquid dispenser 100 is configured such that replacement of the refill portion is quick and easily understood upon visual inspection of the liquid dispenser.

One exemplary method of removing the refill unit includes moving one or both of the pressure plate 122 and the liquid pump 114 from the use position to the load position such that the tube 120 is no longer pinched between the pressure plate and the compression members 128. The liquid container 112, the tube 120, the valve 126, and the nozzle 116 may then be removed from the housing 124. One or more components of the refill unit (e.g., the liquid container 112 and the nozzle 116) may be supported or otherwise removably secured to the housing by a bracket or other similar structure (e.g., seated within a bracket of the housing). As such, removal of one or more of these components may require some minimal amount of effort to release the component from the housing 124.

One exemplary method of installing the refill unit includes placing or securing the liquid container 112 in the housing 124, e.g., seating the liquid container within a bracket of the housing. The tube 120 of the refill unit is placed or otherwise routed between the pressure plate 122 and the compression members 128 of the liquid pump 114. The nozzle 116 and/or the valve 126 of the refill unit is placed or secured in the housing 124, e.g., securing the nozzle between two members of the housing. One or both of the pressure plate 122 and the liquid pump 114 may be moved from the load position to the use position and locked or otherwise fixed such as to clamp or pinch the tube 120 between the pressure plate and the compression members 128.

Further, the refill unit of the liquid dispenser 100 may include the liquid container 112 attached or otherwise coupled to the tube 120 and the nozzle 116 as a single unit. However, in some embodiments, the refill unit of the liquid dispenser 100 may include the liquid container 112 as a separate component from the tube 120 and the nozzle 116, the liquid container being attached or otherwise coupled to the tube and the nozzle before or during the loading of the refill unit into the liquid dispenser 100.

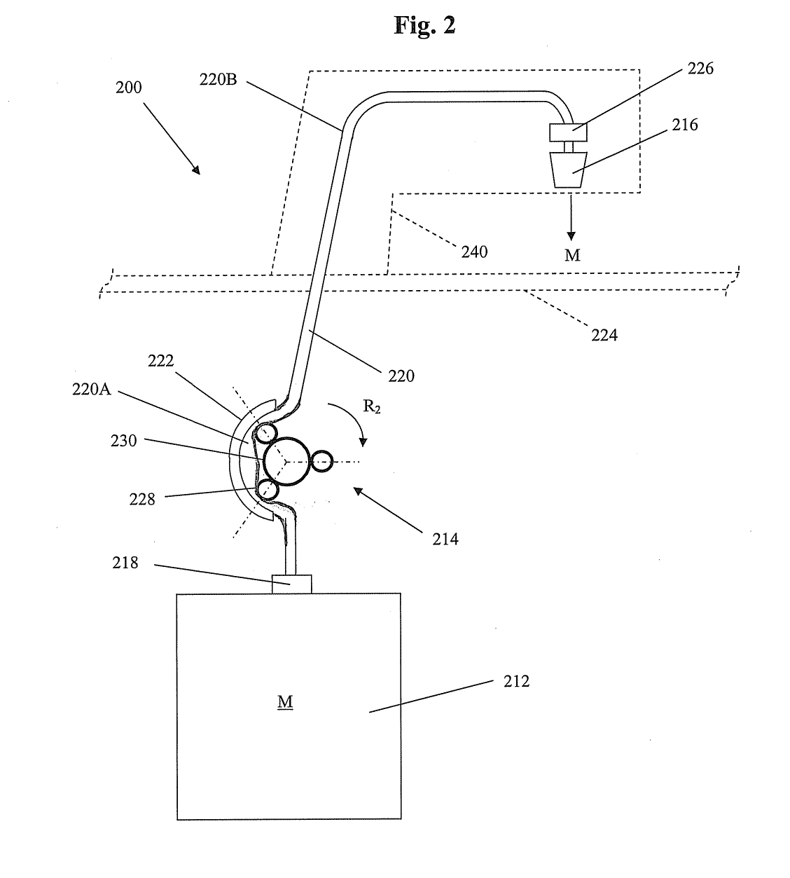

FIG. 2 illustrates a liquid dispenser 200 according to another embodiment of the present application. The liquid dispenser 200 includes a liquid pump 214, a liquid container 212 having an outlet 218, a tube 220, a valve 226, and a nozzle 216. As illustrated in FIG. 2, the liquid dispenser 200 is configured to be mounted or otherwise positioned beneath a countertop 224. At least the tube 220 is configured such that it may be routed through an opening in the countertop 224 and at least partially through a spout 240 extending from the countertop.

Similar to the liquid dispenser 100 illustrated in FIG. 1, the liquid pump 214 of the liquid dispenser 200 is a peristaltic pump having a rotor 230 with three compression members 228 coupled thereto and equally spaced about a circumference of the rotor, or about 120 degrees apart. The rotor 230 is configured to rotate in a direction R₂ (clockwise) such that the compression members 228 compress the tube 220 to move liquid material M from the liquid container 212, through the tube, through the valve 226, and out the nozzle 216. The liquid dispenser 200 also includes a pressure plate 222 that is held stationary as the rotor 230 rotates such that the tube 220 may be compressed by the compression members 228. To facilitate loading of the liquid dispenser 200, one or both of the pressure plate 222 and the liquid pump 214 may be configured to be moveable between a load position and a use position illustrated in FIG. 2.

The liquid pump 214 of the liquid dispenser 200 is configured to provide a continuous stream of the liquid material M from the liquid container 212 stored beneath the countertop 224 to the nozzle 216 with a minimal amount of energy. The rotation of the liquid pump 214 permits the pressure of the liquid material M to build quickly at the valve 226. Once the valve 226 opens, the continual rotation of the liquid pump 214 delivers a continuous stream of the liquid material M to the nozzle 216. The liquid pump 214 may also be configured to “suck back” the liquid material M delivered to the nozzle 216 such that excess liquid material in the nozzle is prohibited from dripping out when the liquid dispenser 200 is not in use. Similar to the liquid dispenser 100 illustrated in FIG. 1, the direction of rotation of the rotor 230 and compression members 228 may be reversed, or rotate counter clockwise, to draw any excess liquid material in the nozzle 216 into the tube 220.

Similar to the liquid dispenser 100 illustrated in FIG. 1, the liquid container 212 of the liquid dispenser 200 may take a variety of shapes, forms, or configurations capable holding a liquid material, e.g., a bag, a pouch, a gusseted bag or pouch, a bottle, or the like. The liquid container 212 may be flexible or rigid, and may be made from a variety of materials. The outlet 218 of the liquid container 212 may be integrally formed with the container or may be a separate component that is attached or otherwise coupled to the container.

As illustrated in FIG. 2, the tube 220 of the liquid dispenser 200 is coupled to the outlet 218 of the liquid container 212 at one end and the valve 226 at the other end. At least a first portion 220A of the tube 220 is flexible such that it may be compressed by the compression members 228 and resilient such that it may quickly return to its natural shape after being compressed. Further, at least a second portion 220B of the tube 220 is rigid enough such that it may be routed through an opening in the countertop 224 and at least partially through the spout 240 extending from the countertop.

The tube 220 may be made from one or more pieces of tubing material. For example, in one exemplary embodiment, the first portion 220A of the tube 220 is made from a separate piece of tubing material than the second portion 220B of the tube. The two pieces of tubing material may be connected, adhered, or otherwise coupled together to form the tube 220.

In other embodiments, a single piece of tubing material is used to form the tube 220. This may be accomplished in a variety of ways. For example, the single piece of tubing may be made of a tubing material that is flexible such that it may be compressed by the compression members 228, resilient such that it may quickly return to its natural shape after being compressed, and rigid enough such that it may be routed through the countertop 224 and at least partially through the spout 240. As another example, the single piece of tubing may be formed such that the wall thickness of the first portion 220A of the tube 220 is less than the wall thickness of the second portion 220B of the tube. This difference in wall thickness permits the first portion 220A of the tube 220 to be more flexible than the second portion 220B of the tube. As yet another example, at least the second portion 220B of the tube 220 may include a sheath or other covering that is rigid enough to permit the tube 220 to be routed through the countertop 224 and at least partially through the spout 240. In one exemplary embodiment, the sheath or covering may be in the form of a wire mesh, formed or cast metal, or plastic.

Similar to the liquid dispenser 100 illustrated in FIG. 1, the nozzle 216 of the liquid dispenser 200 is a foaming nozzle that converts the liquid material M to foam prior to being dispensed. The liquid pump 214 of the liquid dispenser 200 is configured to deliver the liquid material M to the nozzle 216 at a pressure sufficient to permit conversion of the liquid material to foam. Further, the valve 226 may be configured to permit the pressure of the liquid material M from the liquid pump 214 to build before the valve opens and the liquid material is delivered to the nozzle 216. The nozzle 216 and the valve 226 may be included in a common structure made of one or more components that is fluidly coupled to the tube 220.

In some embodiments, the nozzle 216 and/or the valve 226 of the liquid dispenser 200 may be shaped and configured such that they may be routed through the countertop 224 and at least partially through the spout 240. In one exemplary embodiment, the nozzle 216 and the valve 226 are dimensioned such that they may be fed through an opening in the countertop 224 and at least partially through the spout 240. For example, the width or outside diameter of the nozzle 216 and/or the valve 226 may be between about 0.1 inch and about 1 inch to fit through a typical opening in a countertop and at least partially through a typical spout. The nozzle 216 and/or valve 226 may also include a leading edge or surface that is thinner than a trailing edge or surface (e.g., a frustum or truncated cone or pyramid) to facilitate routing of the components through an opening in the countertop 224 and at least partially through the spout 240.

As illustrated in FIG. 2, the liquid container 212 and the tube 220 of the liquid dispenser 200 are configured to be replaceable such that they are collectively the refill unit of the dispenser. Once the liquid material M in the liquid container 212 is consumed, the refill unit may be removed from the liquid dispenser 200 and replaced with a another refill unit with minimal effort. The liquid dispenser 200 is configured such that replacement of the refill portion is quick and easily understood upon visual inspection of the liquid dispenser. In other embodiments, the liquid container 212, the tube 220, the valve 226, and the nozzle 216 may be configured to be replaceable.

One exemplary method of removing the refill unit includes moving one or both of the pressure plate 222 and the liquid pump 214 from the use position to the load position such that the first portion 220A of the tube 220 is no longer pinched between the pressure plate and the compression members 228. The liquid container 212 is removed from a mounting structure beneath the countertop 224, e.g., unseating the liquid container from a bracket beneath the countertop. The second portion 220B of the tube 220 is removed from the spout 240, e.g., the tube is removed from the valve 226 and/or nozzle 216 and is pulled back through the spout and the opening in the countertop 224. Removal of the tube 220 may require some minimal amount of effort to release the tube from the valve 226 and/or nozzle 216. In other embodiments, the valve 226 and/or the nozzle 216 may remain connected to the tube 220 and be removed from the spout 240, e.g., pulled back through the spout and the opening in the countertop 224.

One exemplary method of installing the refill unit includes placing or securing the liquid container 212 to the mounting structure beneath the countertop 224, e.g., seating the liquid container within a bracket beneath the countertop. The first portion 220A of the tube 220 of the refill unit is placed or otherwise routed between the pressure plate 222 and the compression members 228 of the liquid pump 214. The second portion 220B of the tube 220 is routed or fed through the opening in the countertop 224 and at least partially through the spout 240. The second portion 220B of the tube 220 is then connected to the valve 226 and/or the nozzle 216. One or both of the pressure plate 222 and the liquid pump 214 may be moved from the load position to the use position and locked or otherwise fixed such as to clamp or pinch the first portion 220A of the tube 220 between the pressure plate and the compression members 228. In other embodiments, the valve 226 and/or the nozzle 216 may be routed or fed through the opening in the countertop 224 and at least partially through the spout 240, and may be secured within the spout. It may be secured to the spout 240 by, for example, a bracket or a snug fit caused by a sleeve (not shown) having a reduced diameter near the end of the spout.

Further, the refill unit of the liquid dispenser 200 may include the liquid container 212 attached or otherwise coupled to the tube 220 as a single unit. However, in some embodiments, the refill unit of the liquid dispenser 200 may include the liquid container 212 as a separate component from the tube 220, the liquid container being attached or otherwise coupled to the tube before or during the loading of the refill unit into the liquid dispenser 200.

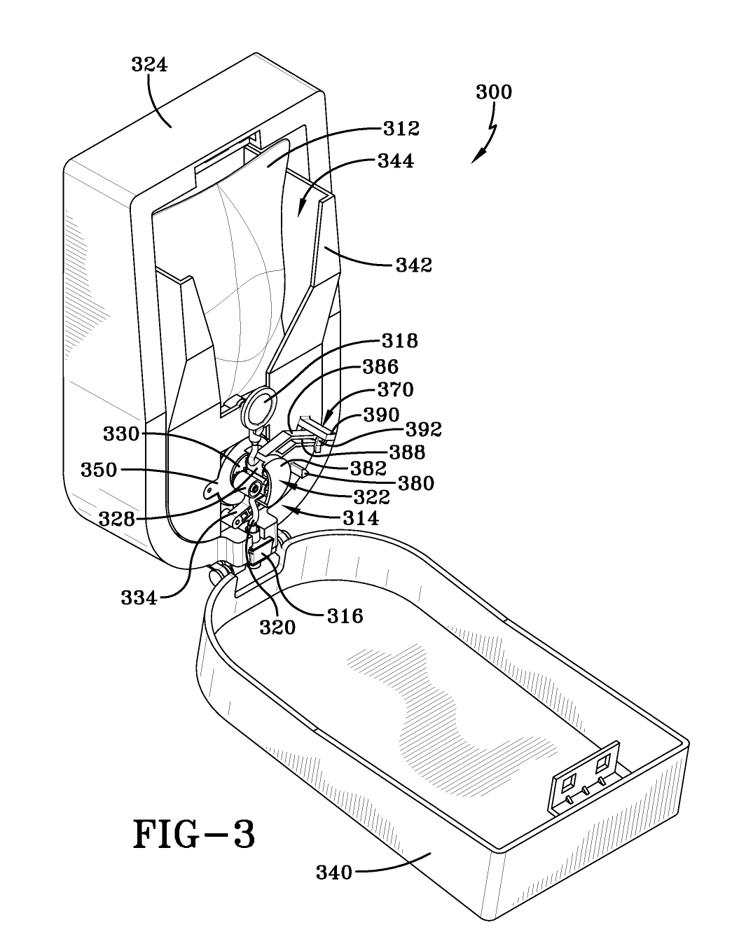

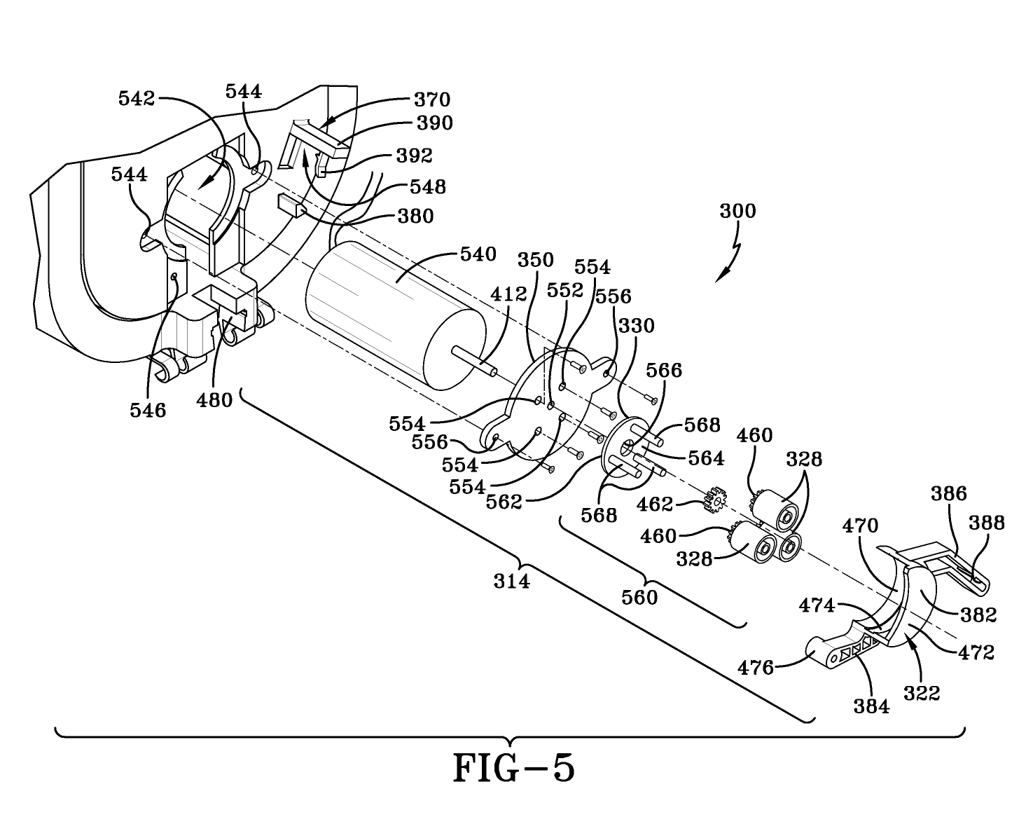

FIGS. 3-8 illustrate a liquid dispenser 300 according to an embodiment of the present application. As shown, the liquid dispenser 300 includes a peristaltic pump 314 and a refill unit. The refill unit of the liquid dispenser 300 includes an outlet tube 320, an attachment adapter 318, a refill container 312, and a foaming nozzle 316. A first end of the outlet tube 320 is fluidly coupled to the refill container 312 via the attachment adapter 318. A second end of the outlet tube 320 is fluidly coupled to the foaming nozzle 316. The peristaltic pump 314 includes three rotating engagement members 328 that are carried by a rotating drive plate 330. The engagement members 328 are equally spaced about a circumference of the drive plate 330, or about 120 degrees apart. As discussed in greater detail below, the engagement members 328 and the drive plate 330 are driven by a motor drive 540 (FIG. 5).

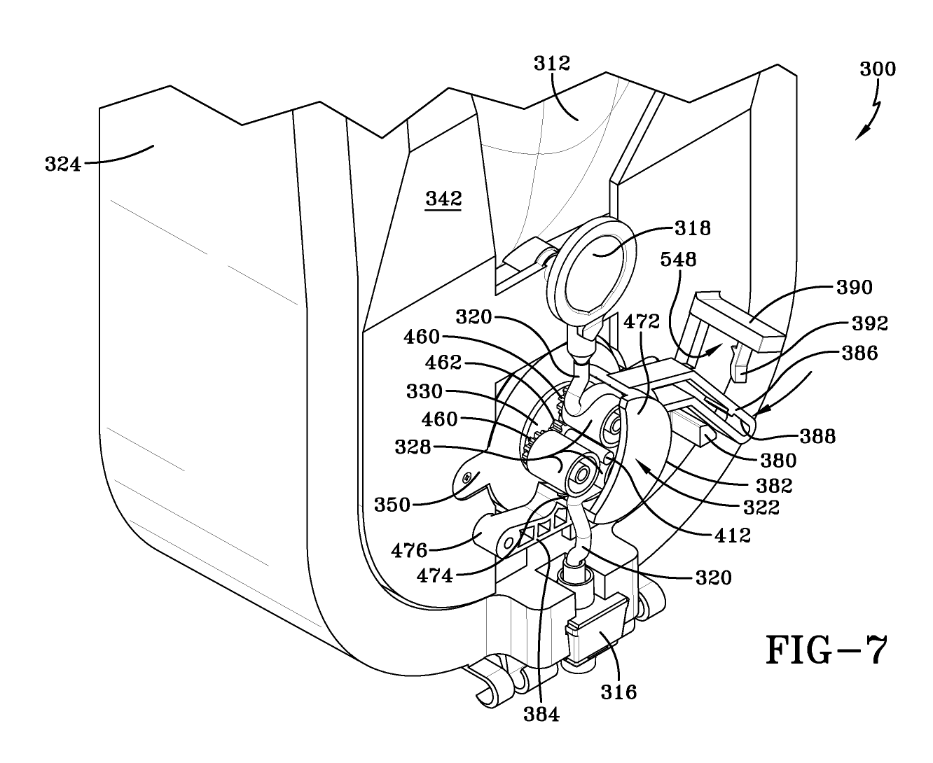

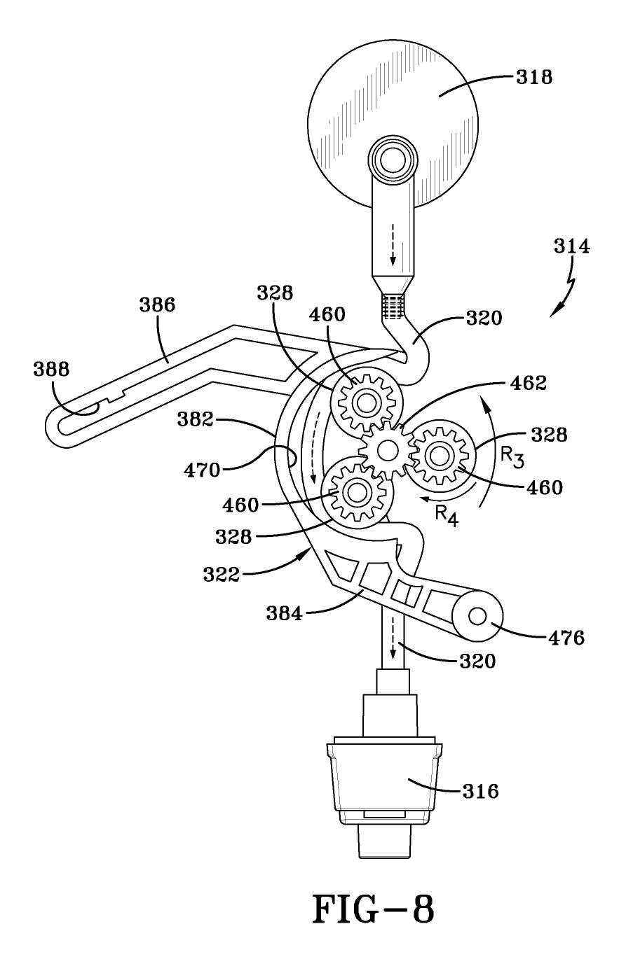

The peristaltic pump 314 of the liquid dispenser 300 is configured to provide a continuous stream of the liquid material from the refill container 312 to the foaming nozzle 316 with a minimal amount of energy. As illustrated in FIG. 8, the drive plate 330 is configured to rotate in a direction R₃ (counter clockwise) such that the engagement members 328 compress the outlet tube 320 to move liquid material from the refill container 312, through the outlet tube, and out the foaming nozzle 316 of the refill unit. As shown, the engagement members 328 include rollers configured to rotate relative to the drive plate 330. The rollers are configured to roll across the outer surface of the outlet tube 320 as the outlet tube is compressed to reduce the amount of friction and wear on the outlet tube. The rollers of the engagement members 328 are configured to rotate in a direction R₄ (clockwise) as the drive plate 330 rotates in a direction R₃ (counter clockwise).

As illustrated in FIGS. 3 and 8, the outlet tube 320 is compressively retained against the rotating engagement members 328 by a guide 322 that is pivotably and removably attached to the dispenser 300. The guide 322 is locked or otherwise held stationary as the engagement members 328 rotate such that the outlet tube 320 may be compressed by the engagement members. As the drive plate 330 rotates, the portion of the outlet tube 320 under compression (i.e., the portion of the outlet tube between the engagement members 328 and the guide 322) closes or occludes to force liquid material to be pumped or moved through the outlet tube and toward the foaming nozzle 316. Once the engagement members 328 pass over the portion of the outlet tube 320, the outlet tube opens to its natural state to induce the flow of liquid material from the refill container 312 to the peristaltic pump 314 (i.e., the opening of the outlet tube creates a vacuum that draws liquid material from the refill container into the outlet tube).

As illustrated in FIG. 3, a housing 324 of the liquid dispenser 300 includes a pivoting door 340 attached thereto that can be moved between an open and a close position. A frame 342 is disposed within the housing 324. The frame 342 provides a retention bin 344 to house and support the refill container 312. As illustrated in FIG. 5, the frame 342 also provides a motor housing 542 dimensioned to receive and retain the motor drive 540. Disposed about the motor housing 542 are a pair of retention apertures 544 and a pivot aperture 546 to respectively retain the motor drive 540 and to pivotably attach the guide 322 to the dispenser 300.

FIG. 5 illustrates an exploded view of the peristaltic pump 314. The motor drive 540 of the peristaltic pump 314 may include any AC (alternating current) or DC (direct current) motor capable of pumping liquid material from the refill container 312, through the outlet tube 320, and out the foaming nozzle 316. The motor drive 540 is attached to the dispenser 300 by a mounting plate 350. The mounting plate 350 includes a centrally-disposed drive aperture 552 configured to receive a drive shaft 412 of the motor drive 540 therethough. The drive aperture 552 is surrounded by a plurality of attachment apertures 554 configured to receive fasteners, such as screws, therethrough. These fasteners threadably retain the motor drive 540 to the mounting plate 350. The mounting plate 350 is attached to the dispenser 300 using fasteners, such as screws, that are received through fastener apertures 556 of the mounting plate. These fasteners are threadably retained in the retention apertures 544 of the frame 342 to secure the mounting plate 350 to the dispenser 300.

As illustrated in FIG. 5, a drive assembly 560 is coupled to the drive shaft 412 of the motor drive 540. The drive assembly 560 includes the drive plate 330 having an inner surface 562 that is opposite an outer surface 564. The drive plate 330 may be formed of any suitable material, such as plastic or aluminum. The drive plate 330 includes a centrally-disposed drive aperture 566 that is surrounded by a plurality of engagement shafts 568 that extend from its outer surface 564. Each of the engagement shafts 568 rotatably carry one engagement member 328. Each engagement member 328 includes a roller that extends from an engagement gear 460 that is positioned proximate to the outer surface 564 of the drive plate 330. In one aspect, the rollers of the engagement members 328 may include a grooved or contoured contact surface that is dimensioned to engage the outer diameter of the outlet tube 320.

Still referring to FIG. 5, in one preferred embodiment, the drive shaft 412 of the motor drive 540 is received through the drive aperture 566 of the drive plate 330 and attached to a drive gear 462 that is proximate to the outer surface 564 of the drive plate. The drive gear 462 is mechanically engaged with each of the engagement gears 460 of the engagement members 328. As the drive gear 462 rotates, it also rotates the engagement gear 460 of each engagement member 328, causing each of the rollers to rotate. In addition to the rotation of the rollers of the engagement members 328, the rotation of the drive gear 462 also causes the drive plate 330 to rotate when the peristaltic pump 314 is in operation. The drive gear 462 may be coupled to the drive plate 330 such that the rotation of the drive shaft 412 rotates the drive gear 462 and the drive plate 330 together. In one embodiment, the drive gear 462 is frictionally coupled to the drive plate 330 such that the rotation of the drive shaft 412 rotates the drive gear and the drive plate together.

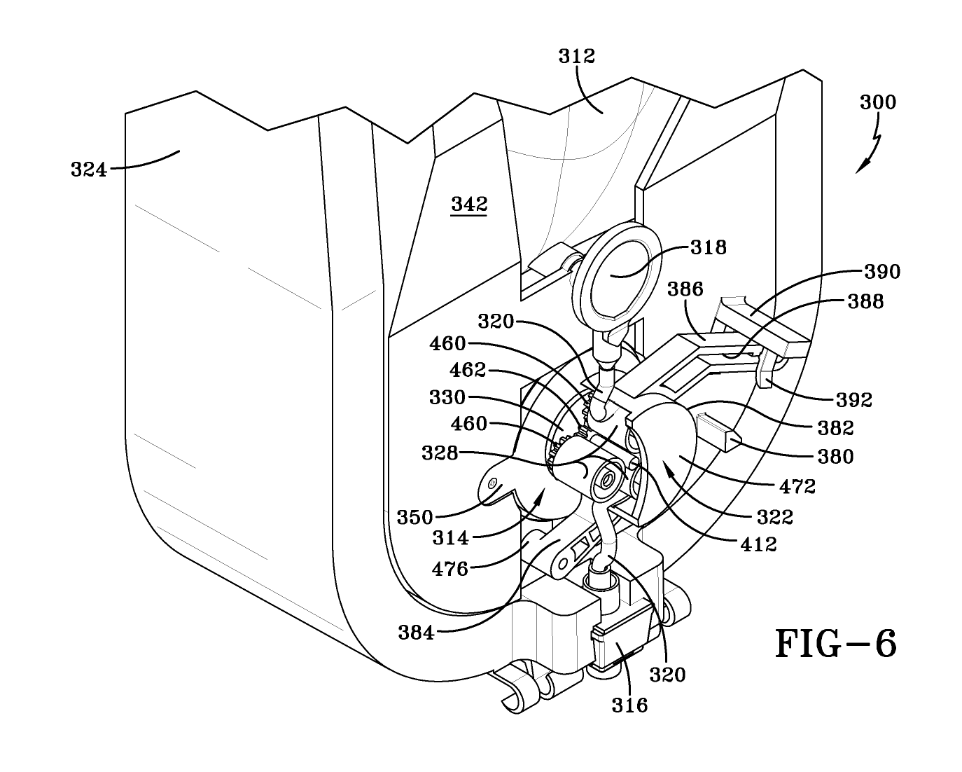

The guide 322 is configured to be pivoted relative to the liquid dispenser 300 such that it is moved away from the engagement members 328 to a load position illustrated in FIG. 7. In the load position, the outlet tube 320 may be positioned between the guide 322 and the engagement members 328. The guide 322 may then be moved from the load position to a use position shown in FIG. 6 and locked or otherwise fixed relative to the engagement members 328 such as to clamp or pinch the outlet tube 320 between the guide and the engagement members.

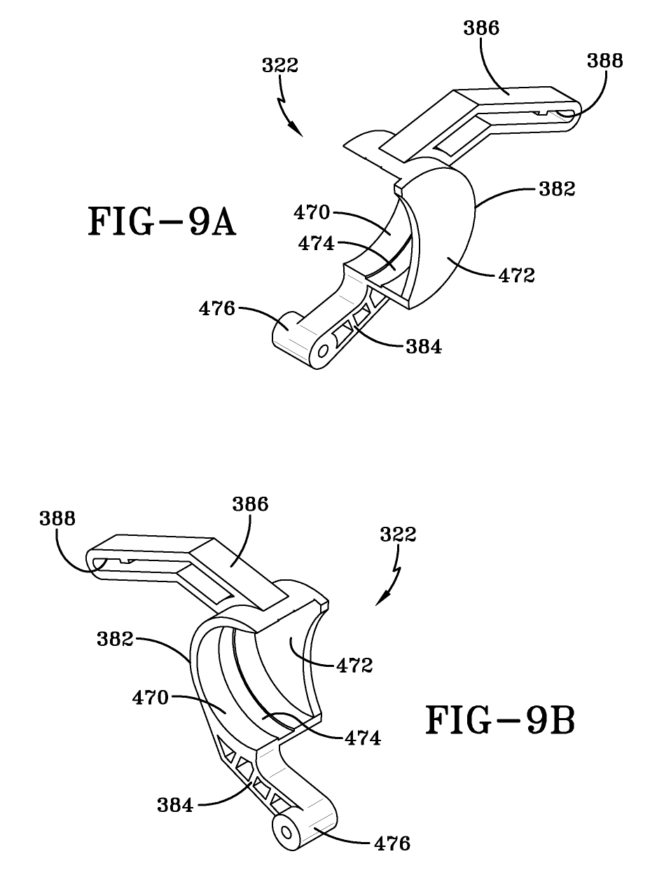

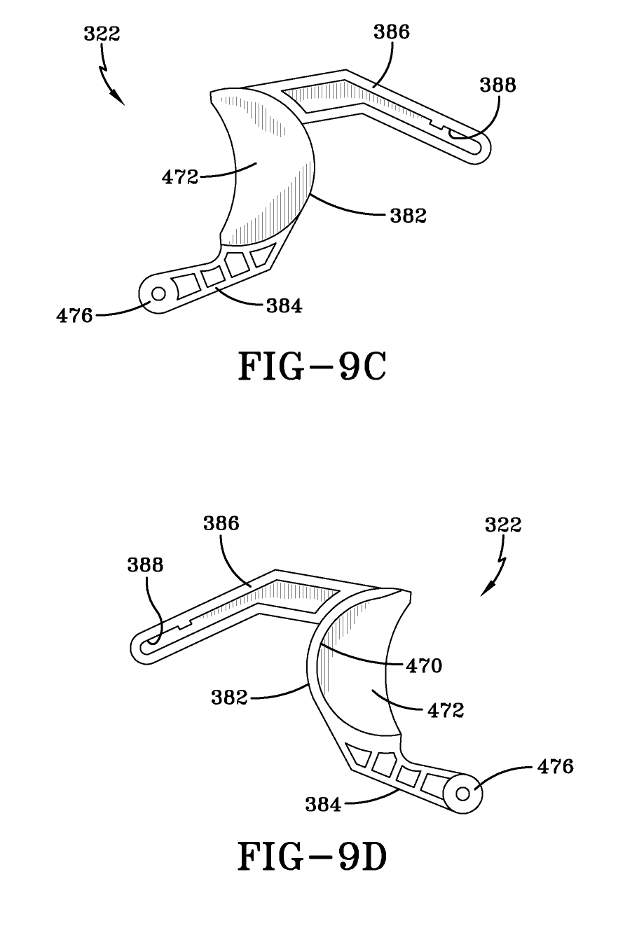

As illustrated in FIGS. 9A-9D, the guide 322 includes a retention section 382 that includes a curved engagement surface 470 that is partially hidden by a cover section 472. In one aspect, it should be appreciated that the radius selected for the curvature of the engagement surface 470 is dimensioned to be compatible with the arcuate path taken during the rotation of engagement members 328. This ensures that the engagement surface 470 of the guide 322 and the engagement members 328 coact to impart a sufficient compression force to the outlet tube 320 when the guide is attached to the liquid dispenser 300 to enable peristaltic pumping action during operation of the dispenser. In addition, the engagement surface 470 includes a retention channel 474, which is configured to hold or guide the routing of the outlet tube 320 in position during the operation of the peristaltic pump 314 to prevent it from becoming dislodged from the rotation of the rollers. A pivot arm 384 extends from the retention section 382 of the guide 322. The pivot arm 384 includes an annular pivot 476 that extends at a substantially right angle from the pivot arm. A lock arm 386 also extends from the retention section 382 in a direction that is substantially opposite to that of the pivot arm 384.

As illustrated in FIGS. 3-5, a retainer 370 and a stop tab 380 extend from the frame 342 in a region proximate to the motor housing 542. The retainer 370 comprises a support arm 390 that extends at a substantially right angle from the frame 342. A retention clip 392 extends from the support arm 390 at a substantially right angle and is substantially parallel to the frame 342 to form a locking channel 548 (FIG. 5). The stop tab 380 is spaced from the locking channel 548 and serves to limit the travel of the guide 322 when it is released or unlocked from the locking channel 548.

The lock arm 386 of the guide 322 includes an engagement channel 388 that is configured to receive the retention clip 392 provided by the retainer 370. In the use position shown in FIG. 6, the lock arm 386 of the guide 322 is retained (locked) in the locking channel 548 by the retention clip 392. When the refill container 312 requires replacement, the lock arm 386 is slid out (unlocked) of the locking channel 548 to release the compressive force that is imparted against the outlet tube 320. The guide 322 is then rotated via the pivot arm 384 to the load position shown in FIG. 7. As such, the guide 322 is configured to be manually pivoted relative to the engagement members 328 without tools by moving the lock arm 386 in and out of the locking channel 548 of the retainer 370. Thus, the outlet tube 320 can be readily removed from the dispenser 300 easily without tools to replace the refill container 312 when it has been depleted.

Furthermore, the pivot arm 384 may be removed from the pivot aperture 546 of the dispenser 300 to replace the refill container 312. It should also be appreciated that the stop tab 380 provides a surface for the lock arm 386 to rest on when it is released from the locking channel 548. Thus, the guide 322 is maintained close to the locking channel 548 such that it is easily accessible during replacement of the refill container 312 or outlet tube 320.

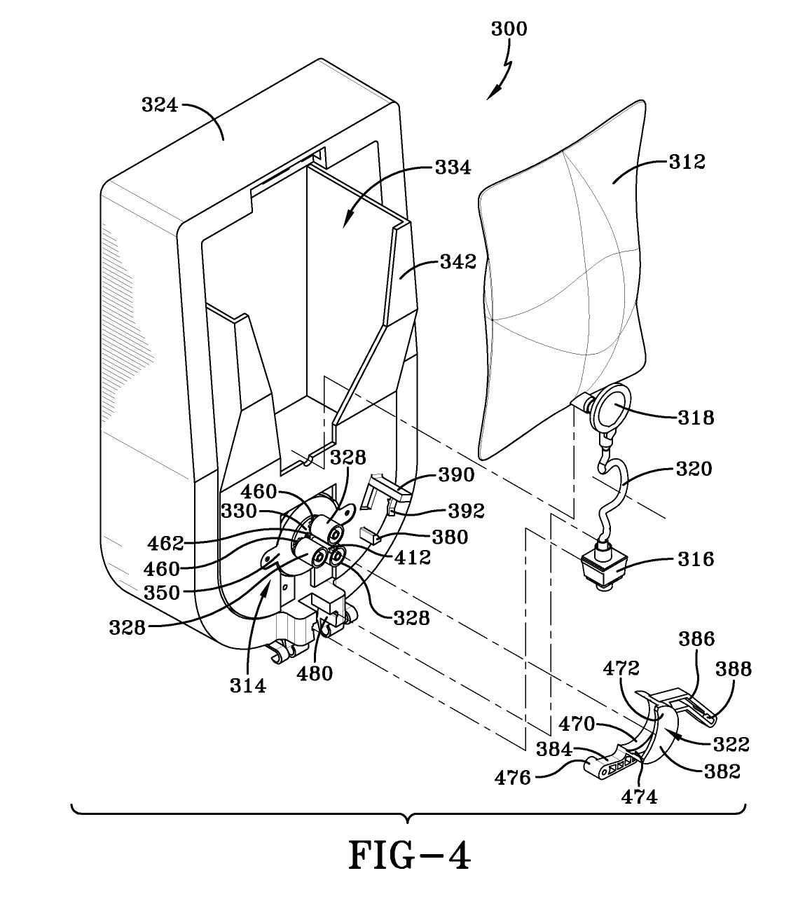

In order to place the dispenser 300 into operation, the refill container 312, attachment adapter 318, outlet tube 320, and foaming nozzle 316 are installed. As illustrated in FIG. 4, the foaming nozzle 316 is slid into a retention slot 480 provided by the portion of the dispenser frame 342 that is at a position below the motor housing 542. Further, the attachment adapter 318 and the refill container 312 are placed in the retention bin 344. With the guide 322 in the load position (FIG. 7) such that the lock arm 386 is removed from the locking channel 548, the outlet tube 320 is routed or otherwise positioned between the engagement members 328 and the guide 322. The outlet tube 320 may be positioned so that it is seated in the retention channel 474 of the curved engagement surface 470 of the guide 322. With the outlet tube 320 in position, the guide 322 is rotated to the use position (FIG. 6) such that the lock arm 386 is retained within the locking channel 548 and the retention clip 392 is received within the engagement channel 388. As a result, the rollers of the engagement members 328 compress the outlet tube 320 against the curved surface 470 of the retention section 382 of the guide 322. The peristaltic pumping force is applied to the outlet tube 320 causing the liquid material from the refill container 312 to be supplied to the foaming nozzle 316 under pressure, whereupon air is injected into the pressurized liquid material, aerating it to form a foam that is dispensed therefrom. Optionally, the guide 322 may be attached to the dispenser 300 such that the pivot 476 is pivotably received in the pivot aperture 546 of the dispenser 300.

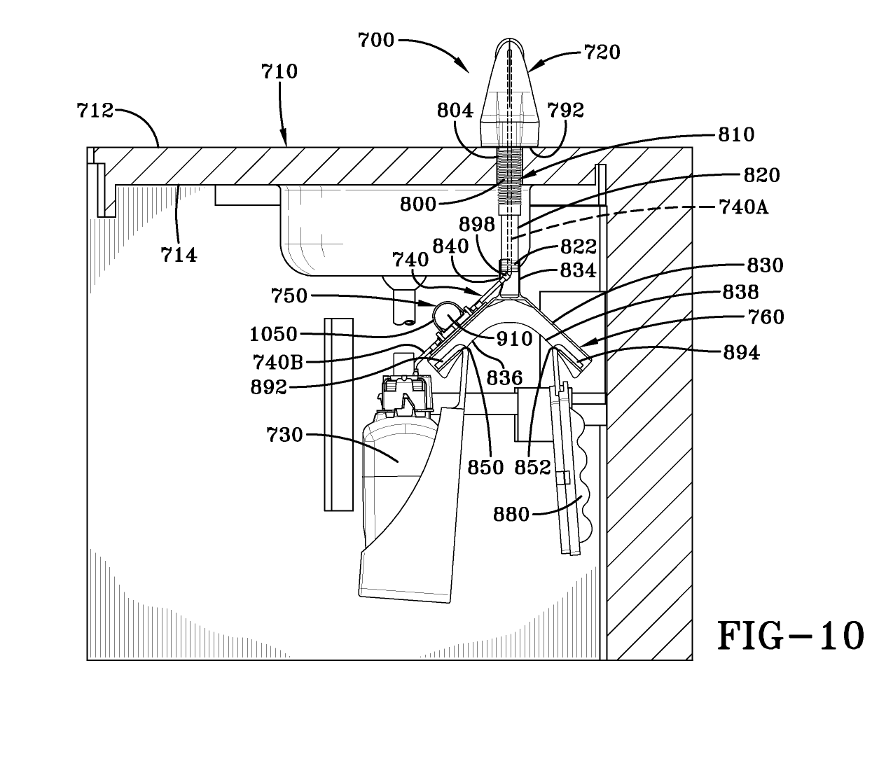

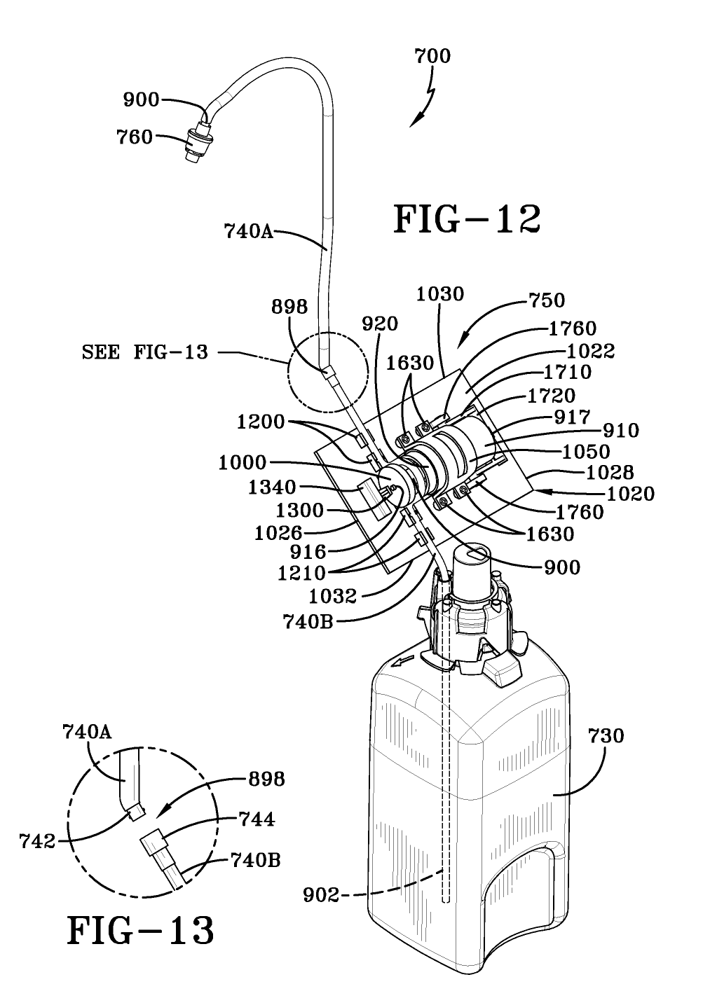

FIGS. 10-12 illustrate a liquid dispenser 700 according to an embodiment of the present application. The liquid dispenser 700 is configured to be mounted to a mounting base 710, as shown in FIG. 10. For example, the mounting base 710 may comprise a countertop surface, such as that used to support a lavatory sink used to wash one's hands in a restroom. The mounting base 710 includes an upper surface 712 and opposed lower surface 714 and may comprise any structure suitable for mounting the liquid dispenser 700 formed from any suitable material, such as wood, plastic, or ceramic for example. In particular, the liquid dispenser 700 includes a spout 720 that is in fluid communication with a refill container 730 via an outlet tube 740. Liquid material, such as liquid soap, sanitizer, moisturizer, or the like that is carried by the refill container 730 is pumped therefrom via the outlet tube 740 by a peristaltic pump 750 that is in operative communication with the outlet tube 740. Thus, as the liquid material passes through the outlet tube 740, it is converted from liquid to a foam by a foaming nozzle 760 (FIG. 12) retained within the spout 720, which is in fluid communication with the outlet tube 740. In addition, the peristaltic pump 750, the refill container 730 and various other components of the dispenser 700 are suspended off of the floor underneath the mounting base 710 by a support hanger 760. As such, the components of the dispenser 700 are able to be concealed underneath the mounting base 710 and hidden from the view of the user, without taking up floor space beneath the mounting base.

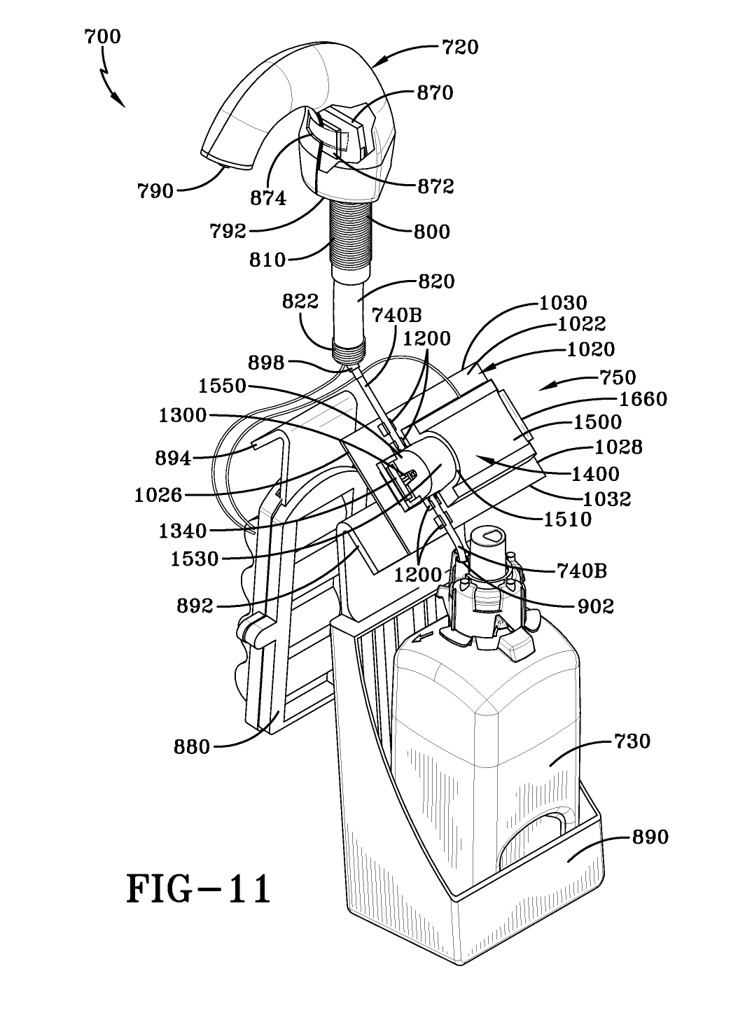

As illustrated in FIGS. 10-11, the spout 720 includes an outlet end 790 that is in fluid communication with the foaming nozzle 760 and a base end 792. Extending from the base end 792 of the spout 720 is an attachment tube 800 that is dimensioned to be received through a mounting aperture 804 that is disposed through the mounting base 710. The attachment tube 800 includes a threaded portion 810 that is configured to receive a threaded collar (not shown) that is threaded against the lower surface 714 of the mounting base 710, thereby securing the spout 720 to the mounting base 710. As such, when the spout 720 is mounted to the mounting base 710, the attachment tube 800 is received through the mounting aperture 804, such that the base end 792 of the spout 720 is adjacent to the upper surface 712 of the mounting base 710, while the attachment collar is engaged against the lower surface 714 of the mounting base 710.

Still referring to FIGS. 10-11, a support tube 820 extends from the attachment tube 800 and is substantially axially aligned therewith. The support tube 820 includes a threaded portion 822 that is configured to be threadably attached to a main tube 834 of the support hanger 760. Extending from the main tube 834 of the support hanger 760 is a pair of angled hanger arms 836 and 838 that extend away from the main tube 834 at an oblique angle to form a substantially “Y” shaped structure. However, it should be appreciated that the hanger arms 836, 838 may be disposed at any suitable angle relative to one another that enables the support hanger to carry the components of the dispenser 700 to be discussed. The main tube 834 includes a tube aperture 840 that is dimensioned to receive the cross-sectional dimension of the outlet tube 740 therethrough, while each of the hanger arms 836, 838 includes respective support ledges 850 and 852, each of which angle downward away from the main tube 834. In one aspect, the attachment tube 800, the support tube 820, the main tube 834, and the hanger arms 836, 838 may comprise any suitable cross-sectional shape, such as a rectilinear or curvilinear shape or any combination thereof.

As illustrated in FIG. 11, a control module 870 is disposed within the spout 720. The control module 870 includes the necessary hardware and software for carrying out the functions to be discussed. Coupled to the control module 870 is a motion sensor 872 that is disposed behind a window 874 provided by the spout 720. Specifically, the window is transparent to electromagnetic signals, such as IR (infrared signals), as well as any other signals, including RF (radio frequency) signals. The motion sensor 872 may comprise an IR (infrared) sensor that is configured to detect the presence of the hands or motion of the user relative to the dispenser 700. The control module 870, the motion sensor 872, and the peristaltic pump 750 are powered by a portable power source 880, such as a battery, DC (direct current); however, they may be configured to operate on electrical power supplied from any power source, including AC (alternating current) power supplied from a standard electrical wall outlet. It is also contemplated that the control module 870 and motion sensor 872 may be powered by the portable DC power source 880, while the peristaltic pump 750 operates from AC power supplied from an electrical wall outlet, although the control module 870, motion sensor 872, and pump 750 may be powered by any combination of DC and AC power.

With reference to FIGS. 10 and 11, the refill container 730 comprises any suitable liquid-carrying container that is dimensioned to be carried by a carrier 890. The carrier 890 includes a hook arm 892 that is configured to be received upon the hanger ledge 852 provided by the support hanger 760, while the power source 880 is also configured with a hook arm 894 that is configured to be received upon the hanger ledge 852. As such, when the hook arms 892 and 894 of the refill container carrier 730 and the portable power source 880 are disposed upon the hanger ledges 850 and 852 of the support hanger 760, they are suspended off of the floor or other surface that is beneath the mounting base 710. This reduces clutter under the mounting base 710, thus increasing the space that is available for use for storage or other uses under the mounting base 710. Suspending the refill container 730 under the mounting base 710 also reduces the possibility that the liquid material within the refill container 730 is inadvertently spilled when the area under the mounting base 710 is accessed by users.

As illustrated in FIGS. 12 and 13, the outlet tube 740 comprises any suitable flexible and compressible tube that includes an outlet end 900 that is fluidly coupled to the foaming nozzle 760 and an opposed inlet end 902 that is configured to be in fluid communication with the liquid material disposed within the refill container 730. As such, the outlet tube 740 is routed into the tube aperture 840 of the support tube 820 and through the attachment and support tubes 800,820, such that the foaming nozzle 760 is attached to the outlet end 900 of the outlet tube 740. The remaining portion of the outlet tube 740 is routed about the peristaltic pump 750 in a manner to be discussed, such that the inlet end 902 of the outlet tube 740 is in fluid communication with the liquid material carried by the refill container 730.

Because a portion of the outlet tube 740 is routed through the attachment and support tubes 800,820 and attached to the foaming nozzle 760 that is concealed within the spout 720, it is inaccessible to the user, making it difficult to replace the outlet tube 740 when it has become worn due to its operative contact with the peristaltic pump 750. As such, the outlet tube 740 includes a quick-release coupling 898 that allows the outlet tube 740 to be separated into two sections designated by identifiers “A” and “B”, whereby section 740A is disposed through the attachment and support tubes 800,820 and coupled to the foaming nozzle 760, and section 740B is in operative contact with the peristaltic pump 750 and fluidly coupled to the refill container 730. Specifically, the coupling 898 is configured such that the outlet tube section 740A includes a primary coupling end 742 that is removably received within a secondary coupling end 744 provided by the outlet tube section 740B. Thus, upon decoupling the sections 740A and 740B at the quick-release coupling 898, access to outlet tube section 740B can be easily obtained, thereby facilitating the replacement of the outlet tube 740B which may need routine replacement due to wear resulting from its contact with the moving portions of the peristaltic pump 750.

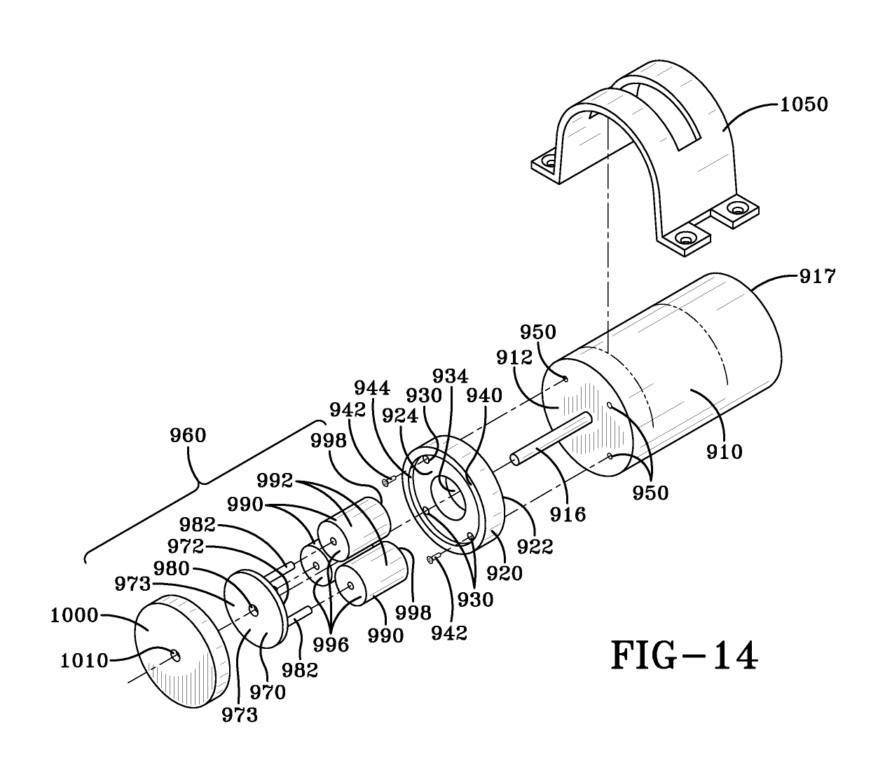

As illustrated in FIG. 14, the peristaltic pump 750 used to pump liquid material through the outlet tube 740 includes a motor drive 910. The motor drive 910 includes a drive end 912 from which extends a rotating shaft 916 and an opposed base end 917. In addition, the motor drive 910 is powered by the portable power source 880 that is coupled thereto, as shown in FIG. 11, and is controlled by control signals supplied by the control module 870 also coupled thereto. The pump 750 also includes an annular spacer 920, having an attachment surface 922 opposite a drive surface 924, which includes a plurality of mounting apertures 930 that are disposed about a centrally located shaft aperture 934. The drive surface 924 includes a wall 940 that extends about the periphery of the spacer 920, which forms a corresponding guide edge 944. The spacer 920 is retained to the motor drive 910 by fasteners 942, such as screws, that are received through the mounting apertures 930 of the spacer 920 and threadably received in corresponding retention apertures 950 dispensed in the drive end 912 of the motor drive 910. As such, when attached to the motor drive 910 using the fasteners 942, the attachment surface 922 is adjacent to the drive end 912 of the motor, allowing the rotating shaft 916 to extend through the shaft aperture 934.

Still referring to FIG. 14, attached to the rotating shaft 916 of the motor drive 910 is a drive assembly 960 that includes an annular drive plate 970 having opposed inner and outer surfaces 972, 973 through which a centrally disposed drive aperture 980 is disposed. Extending from the inner surface 972 of the drive plate 970 at a substantially right angle are a plurality of engagement shafts 982 that surround the drive aperture 980. Each of the engagement shafts 982 rotatably carry an engagement member 990, such as a roller, which is substantially cylindrical in shape and provides an engagement surface 992 bounded by opposed ends 996 and 998. The drive aperture 980 of the drive plate 970 is attached to the rotating shaft 916 of the motor drive 910 using any suitable means of fixation, such that the ends 998 of the engagement members 990 are adjacent to the drive surface 924 of the spacer 920. As such, the ends 998 of the members 990 are guided by the guide edge 994 formed by the wall 940 of the spacer 920. The drive assembly 960 also includes a cap disk 1000 that is substantially axially aligned with the drive plate 970. The cap disk 1000 includes a centrally-disposed mounting aperture 1010 therethough that is attached to the portion of the rotating shaft 916 that extends through the drive aperture 980 of the drive plate 970.

As illustrated in FIGS. 15-18B, the motor drive 910 and drive assembly 960 are supported upon a mounting plate 1020 that has a mounting surface 1022 and opposed base surface 1024 that are bounded by a drive edge 1026, a lock edge 1028, and lateral side edges 1030, 1032. It should be appreciated that the mounting plate 1020 may comprise any suitable material, such as plastic, aluminum, steel, or the like. Extending from the mounting surface 1022 of the plate 1020 are spaced concave axially-aligned support arms 1040,1042, which are dimensioned to cradle and support the curvature or cross-sectional shape of the motor drive 914. The motor drive 914 is retained to the support arms 1040,1042 of the mounting plate 1020 by a clamp 1050. The clamp 1050 is fastened to the mounting plate 1020 by suitable fasteners 1060, such as screws, that are threadably received within corresponding mounting apertures 1070 provided by the mounting surface 1022 of the mounting plate 1020. Positioned between the drive edge 1026 of the mounting plate 1020 and the support arm 1040 is a guide 1100, which includes a substantially concave guide surface 1110. The concave guide surface 1110 is dimensioned to allow sufficient clearance for the engagement members 990 to freely rotate as they are driven by the motor drive 910. Laterally disposed on each side of the guide 1110 is a pair of axially-aligned tube retainers 1200 and 1210, which retain the outlet tube 740 by snap or friction fit to the mounting plate 1020. The retainers 1200,1210 also serve to keep the outlet tube 740 positioned adjacent to the rotating engagement elements 990 during operation of the peristaltic pump 750 in a manner to be discussed. Extending from the mounting surface 1022 of the mounting plate 1020 at a point between the guide 1110 and the drive edge 1026 is a stop 1300. The stop 1300 is spaced from the guide 1100 so as to form a guide channel 1310 that is dimensioned to receive a portion of the rotating cap disk 1000 therein. Also extending from the mounting surface 1022 and disposed between the stop 1300 and the drive edge 1026 is a lock clip 1340, which is utilized to selectively retain a cover 1400 to the mounting plate 1020 in a manner discussed below.

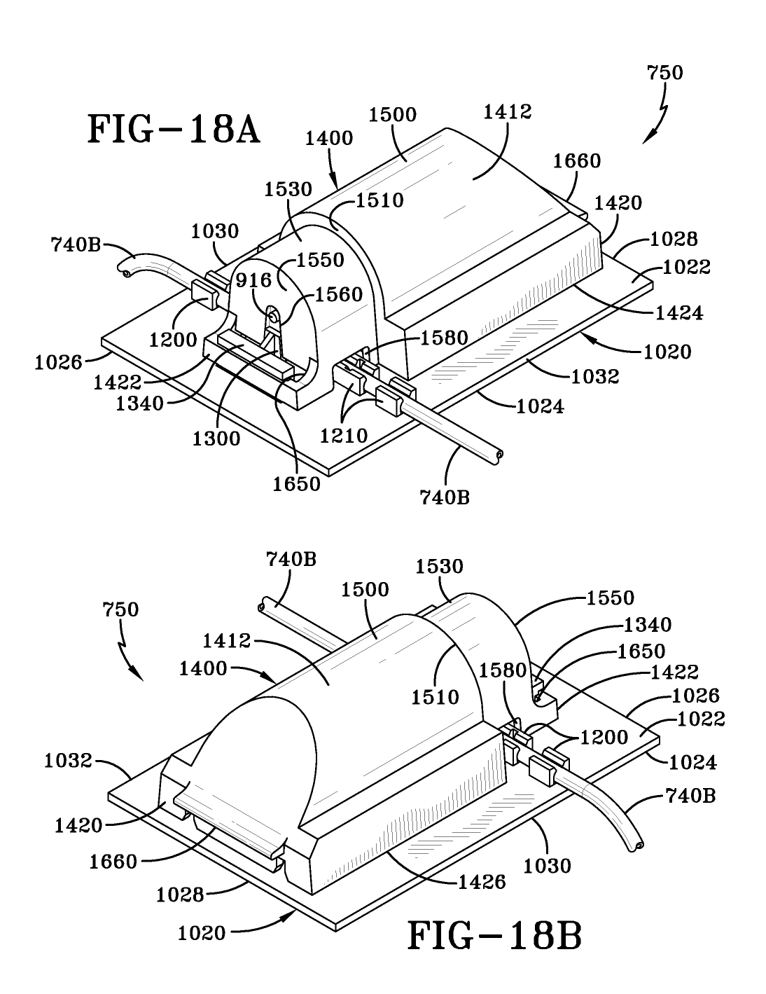

Still referring to FIGS. 15-18B, the cover 1400 includes opposed inner and outer surfaces 1410,1412, which are bounded by opposed lock and guide edges 1420,1422 and opposed lateral side edges 1424,1426. The cover 1400 includes a primary section 1500 that extends between the lock edge 1420 and a transition wall 1510, while a secondary section 1530 that extends from the transition wall 1510 is terminated by a guide wall 1550 that is proximate to the guide edge 1422. The guide wall 1550 includes an elongated slot 1560 that extends from a bottom edge 1570 of the wall 1550 to accommodate the rotating shaft 916, which extends through the mounting aperture 1010 of the cap disk 1000. The lateral edges 1424,1426 of the secondary section 1530 include notches 1580 that are dimensioned to receive the outlet tube 740 therethrough when the cover 1400 is in a closed position, as shown in FIGS. 18A-18B.

Still referring to FIGS. 15-18B, the inner surface 1410 of the primary section 1500 is formed with a substantially concave cross-section to enclose the motor drive 914, while the inner surface 1410 of the secondary section 1530 is also configured with a substantially concave cross-section that provides an engagement surface 1600. Extending from the guide wall 1550 to the guide edge 1422 of the cover 1400 is a lock slot 1650, which is dimensioned to receive the lock clip 1340 of the mounting plate 1020 therein to retain the cover 1400 in a closed position in a manner to be discussed. Extending from the lock edge 1420 of the cover 1400 is a lock tab 1660, which facilitates the opening and closing of the cover 1400.

As illustrated in FIG. 15, the cover 1400 is pivotably retained to the mounting plate 1020 by a hinge assembly 1700 that is proximate to the lock edge 1028 of the mounting plate 1020. The hinge assembly 1700 includes a hinge arm 1710 that has a cylindrical pivot bar 1720 from which extends at a substantially right angle, a pair of spaced, substantially parallel legs 1730,1732. The legs 1730,1732 each include a pivot 1740, which are received in corresponding apertures 1750 disposed in a pair of spaced bosses 1760 that extend from the mounting surface 1022 of the mounting plate 1020. A pair of axially-spaced pivot jaws 1780 are disposed on the inner surface 1410 of the cover 1400 at a point proximate to the lock end 1420 and are dimensioned to be snap-fit onto the pivot bar 1720, thus allowing the cover 1400 to pivot about the pivot bar 1720. Thus, the hinge arm 1710 is pivotably retained to the mounting plate 1020 via the pivots 1740 and pivotably retained to the cover 1400 via the pivot bar 1720.

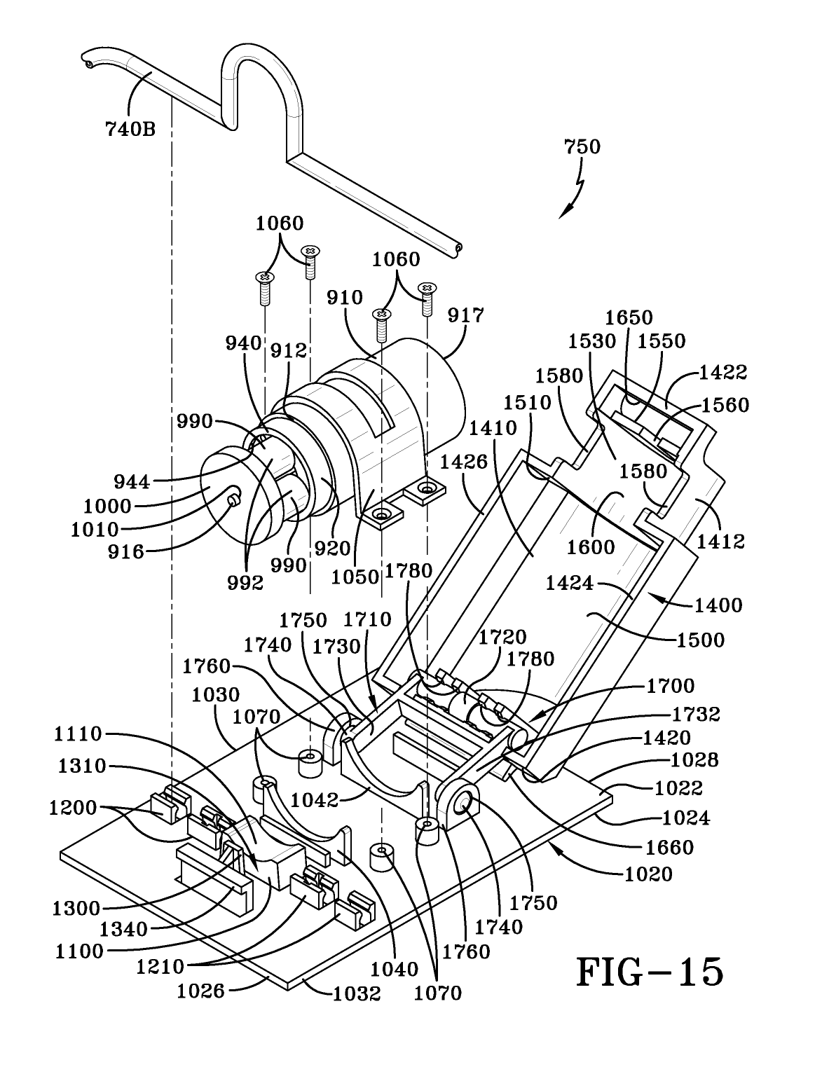

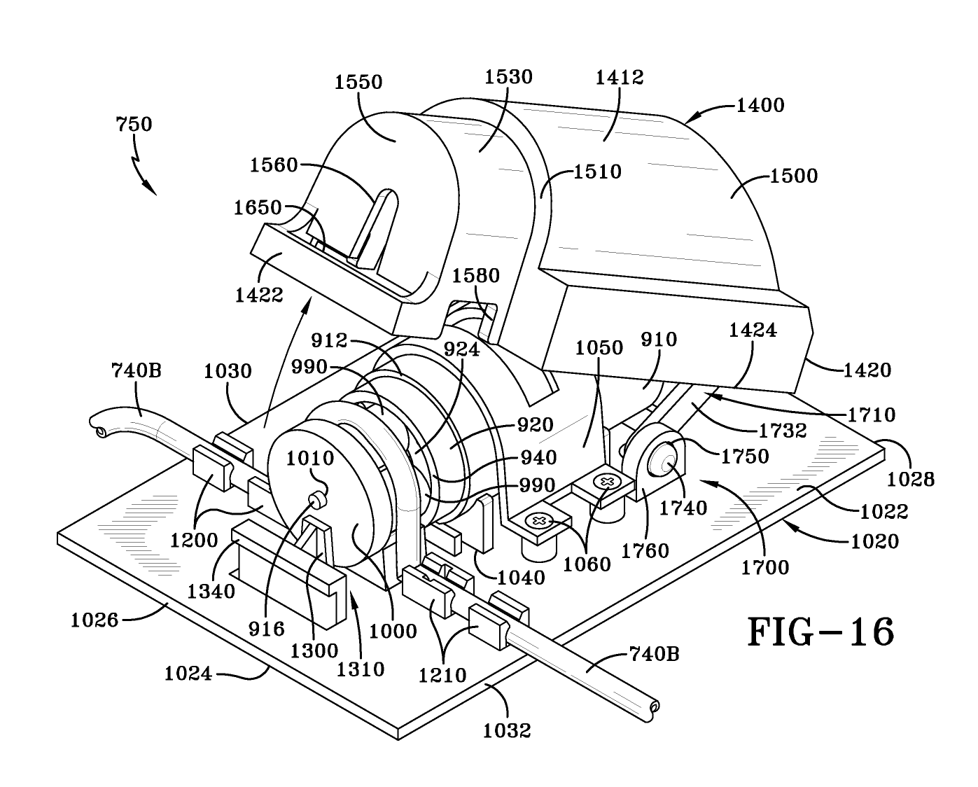

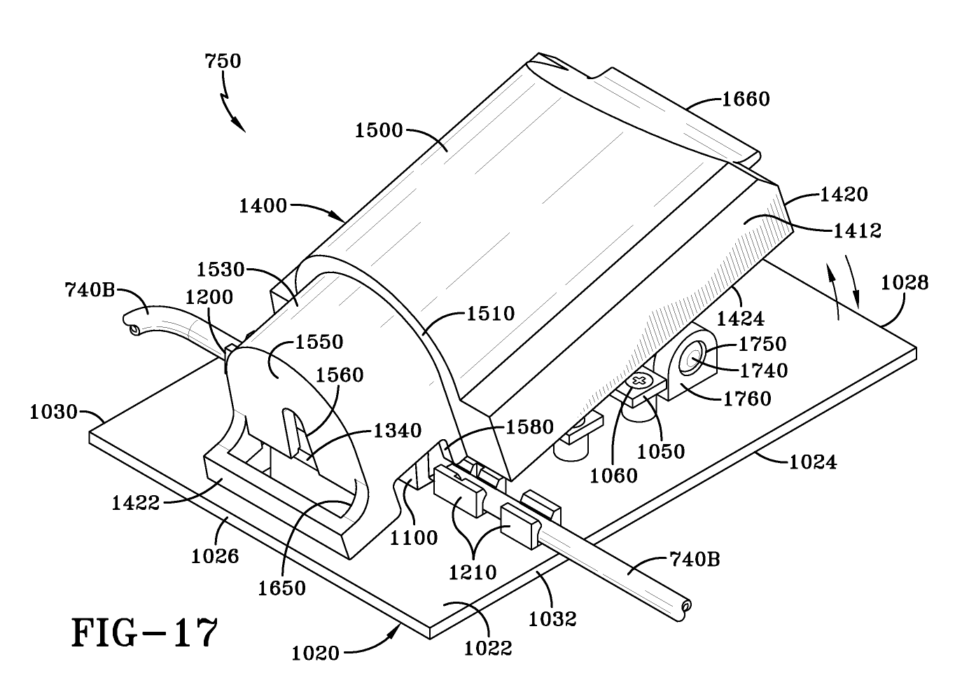

As such, when the cover 1400 is placed into a closed position, as shown in FIGS. 18A-18B, whereby the lateral edges 1424,1426 and lock and guide edges 1420,1422 of the cover 1400 are proximate to the mounting surface 1022 of the mounting plate 1020, the primary section 1500 encloses the motor drive 910, while the engagement surface 1600 of the secondary section 530, is brought into compressive engagement with the outlet tube 740B. In other words, when the cover 1400 is in a closed position, the outlet tube 740B is compressed between the engagement surface 992 of the engagement member 990 and the engagement surface 1600 of the secondary section 530. To place the cover 1400 into a closed position, the cover 1400 is initially tilted so that the lock edge 1420 of the cover 1400 is raised away from the mounting plate 1020 via the hinge arm 1710, allowing the guide edge 1422 of the cover 1400 to come forward, as shown in FIG. 16, such that the lock clip 1340 extending from the mounting plate 1020 is received within the lock slot 1650 of the cover 1400. Once the lock clip 1340 is positioned within the lock slot 1650, the guide edge 1420 of the cover 1400 is pivoted downward via the hinge arm 1710 toward the mounting plate 1020, such that the hinge arm 1710 is substantially parallel to the mounting plate 1020, which causes the cover 1400 to be retained in the closed position. Correspondingly, to place the cover 1400 into an opened position, the lock tab 1660 is lifted, as shown in FIG. 17, so that the lock edge 1420 of the cover 1400 is raised away from the mounting plate 1020 by the pivoting movement of the hinge arm 1710. Once the lock edge 1420 is raised away from the mounting plate 1020 a sufficient distance, the guide edge 1422 is permitted to also be raised, allowing the lock tab 1340 to be released out of the lock slot 1650 of the cover 1400.

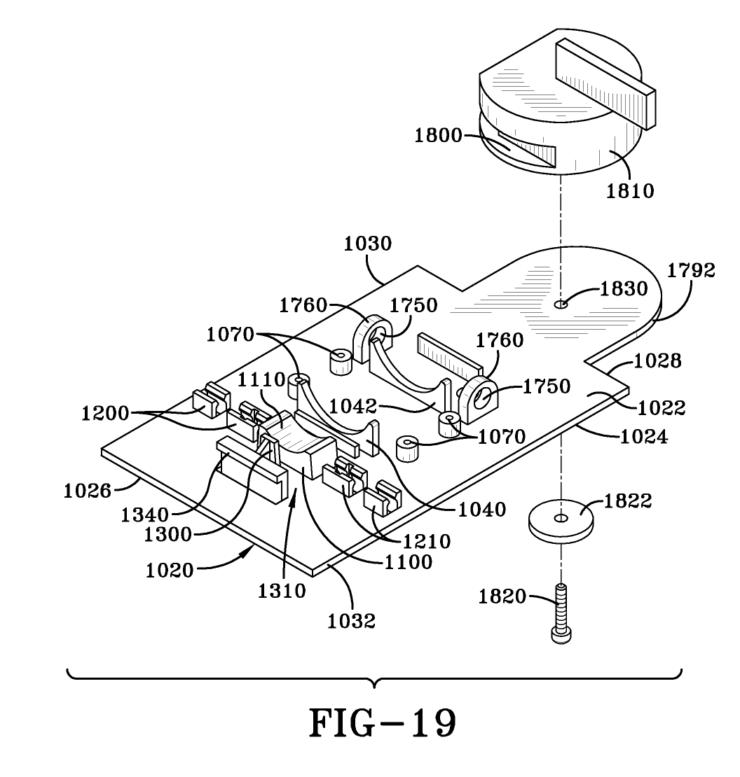

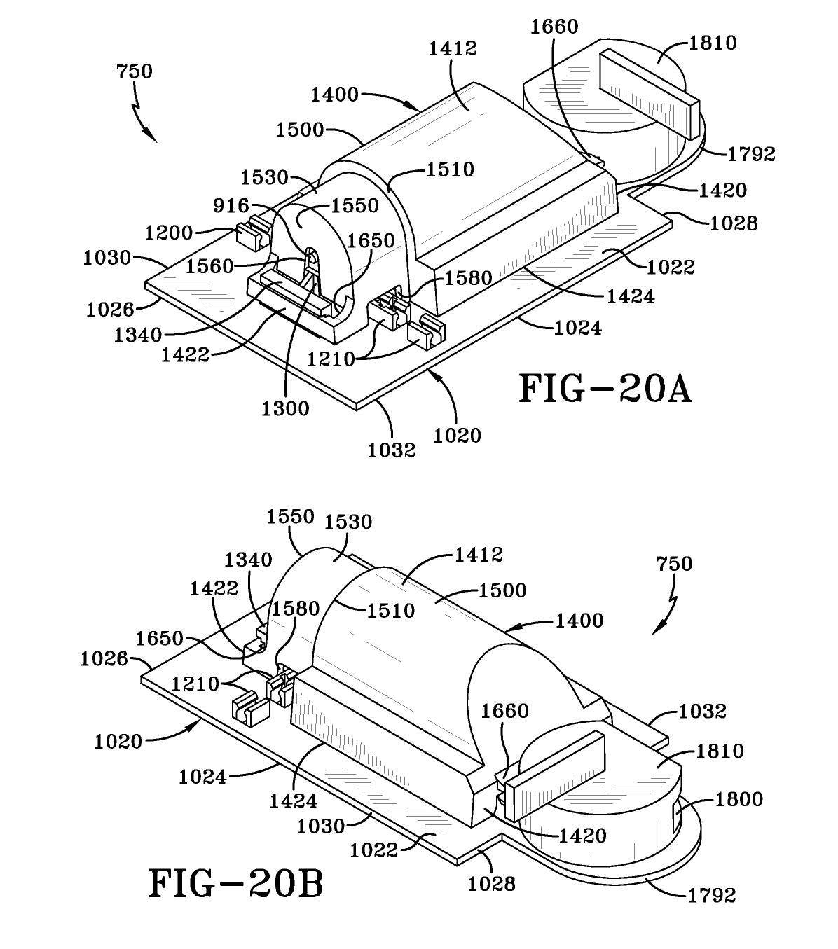

In another embodiment, shown in FIGS. 19-20B, the mounting plate 1020 may include a lock section 1792 that extends away from the lock edge 1028 of the mounting plate 1020. The lock tab 1660 provided by the cover 1400 is configured to be received within a lock channel 1800 disposed in a rotating cam lock 1810, which is pivotably mounted to the lock section 1792. Specifically, the cam lock 1810 is pivotably retained to the mounting plate 1020 by a pin 1820 that is received through an aperture 1830 disposed through the lock section 1792. As such, when the cover 1400 is in a closed position, as previously discussed above, the cam lock 1810 is rotated so that the lock tab 1660 of the cover 1400 is received within the lock channel 1800 therein, thereby preventing the cover 1400 from becoming inadvertently moved to an open position. Alternatively, the cam lock 1810 may be rotated so that the lock tab 1660 is released out of the lock channel 1800, allowing the cover 1400 to be opened in the manner previously discussed.

Thus, to place the liquid dispenser 700 into operation, the cover 1400 is placed in an opened position and the outlet tube 740B is routed so that lays upon the engagement members 990 of the peristaltic pump 750, as shown in FIGS. 15-16. Once the outlet tube 740B is in position, the cover 1400 is moved to a closed position, such that the outlet tube 740B is routed through each of the notches 1580 provided by the secondary section 1530 of the cover 1400. Upon closing the cover 1400, the outlet tube 740B is compressed between the engagement surface 1600 provided by the secondary section 1530 of the cover 1400 and the engagement surface 992 provided by the engagement members 990 provided by the drive assembly 960 of the peristaltic pump 750.

After the outlet tube 740B is operatively coupled with the pump 750 by the cover 1400, the motor drive 910 is activated upon the detection of the movement or presence of the user's hands or body by the motion sensor 872. Once activated, the motor drive 910 rotates the drive plate 970 of the drive assembly 960 via the rotating shaft 916. As the drive plate 970 is rotated, the engagement members 990 are rotated and compress the outlet tube 740B against the concave engagement surface 1600 of the cover 1400, thereby generating a peristaltic pumping force that is applied to the outlet tube 740B. This causes the liquid material from the refill container 730 to be supplied to the foaming nozzle 760 under pressure, whereupon air is injected into the pressurized liquid material, aerating it to form a foam that is dispensed from the spout 720.

One advantage of one or more embodiments of the present invention is that a peristaltic pump of a liquid dispenser has a movable guide that compresses an outlet tube against rotating engagement members. Another advantage of the present invention is that a liquid dispenser provides a movable guide that enables access to the outlet tube so that the refill container and foaming nozzle that are fluidly coupled thereto can be easily removed when they need to be replaced. Yet another advantage of the present invention is that the guide is configured to be quickly and easily moved and positioned without tools, thus reducing the amount of time that the dispenser is taken out of service when the refill container is being replaced. Still another advantage of the present invention is that a peristaltic pump for a counter mounted liquid dispenser has a pivoting cover, which compresses an outlet tube against rotating engagement members of the pump, and can be readily released to allow removal of the outlet tube and attached refill container from the dispenser.

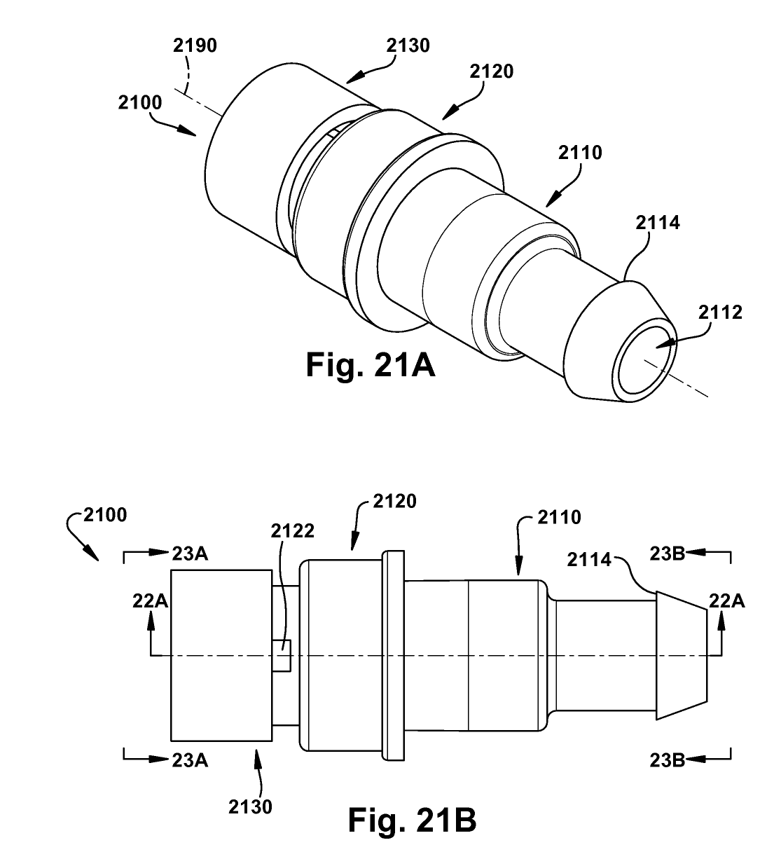

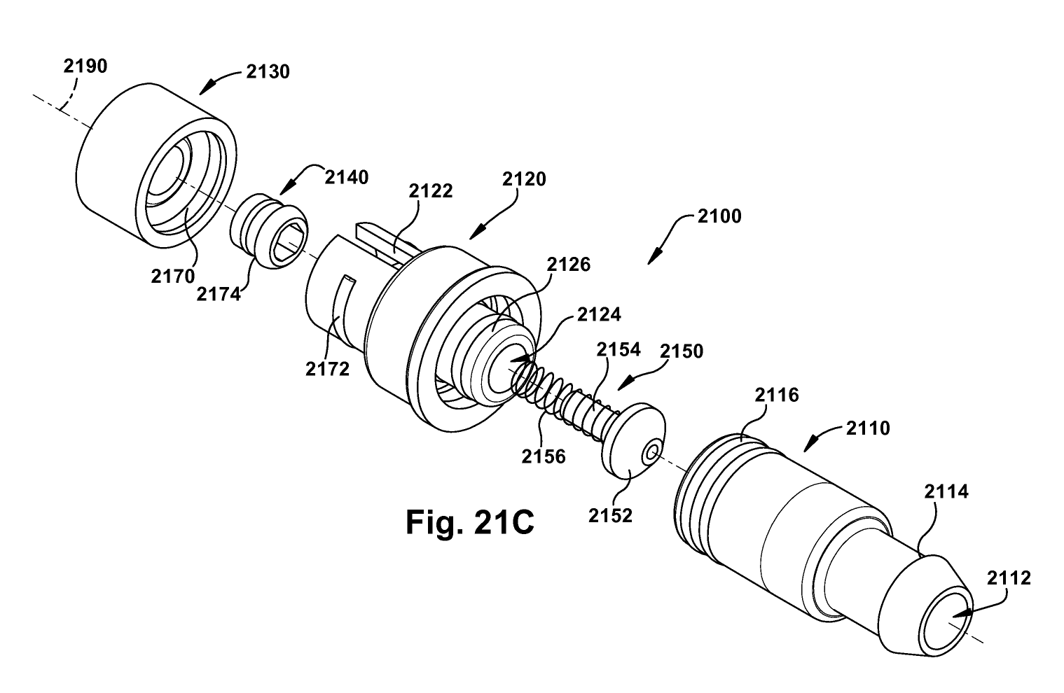

FIGS. 21A-23B illustrate a foaming nozzle 2100 according to an embodiment of the present application. The foaming nozzle 2100 is configured for use with the liquid dispenser of the present application and may be included with a refill unit of the dispenser. The foaming nozzle 2100 is configured to convert liquid material L from a liquid pump of the dispenser to foam F. The foaming nozzle 2100 is configured such that liquid material may be converted to foam without the use of a separate air pump to inject air into the liquid material.

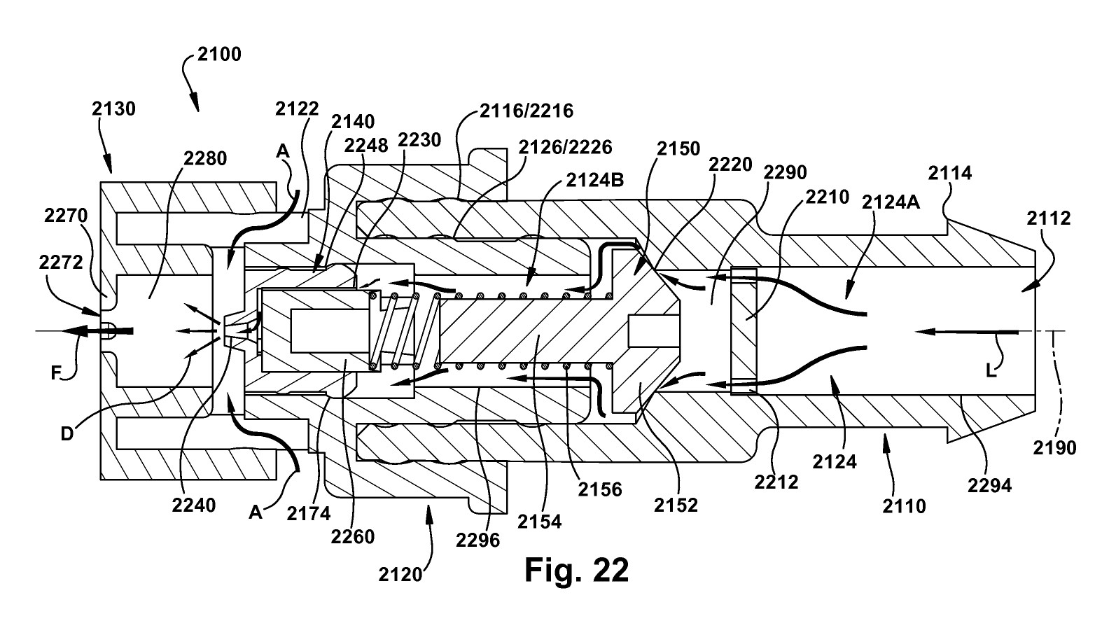

The foaming nozzle 2100 includes an inlet portion 2110, a housing portion 2120, and a foaming chip portion 2130 coupled together to form the foaming nozzle having a longitudinal axis 2190. The housing portion 2120 is coupled to the inlet portion 2110 at a first end and the foaming chip portion 2130 at a second end. As illustrated in FIGS. 21C and 22, a foaming spout 2140 is also coupled to the housing portion 2120 and a valve assembly 2150 is positioned within a flow channel 2124 formed by the inlet portion 2110 and the housing portion 2120. In a preferred embodiment, the components of the foaming nozzle 2100 are made of molded plastic, however other materials and methods of manufacturing may be used, such as formed or cast metal.

The components of the foaming nozzle 2100 may be coupled together in a variety of ways. For example, as illustrated in FIGS. 21C and 22, a second end of the inlet portion 2110 comprises exterior threads 2116 and interior threads 2226 configured to mate with interior threads 2216 and exterior threads 2126, respectively, of the first end of the housing portion 2120. This threaded connection removably couples the inlet portion 2110 to the housing portion 2120 and forms a fluid tight seal between the inlet portion and the housing portion. The foaming chip portion 2130 includes an interior groove 2170 configured to mate with an exterior protrusion 2172 of the housing portion 2120 to removably couple the foaming chip portion to the housing portion. Further, the foaming spout 2140 is press fit into the second end of the housing portion 2120. A lip 2174 of the foaming spout 2140 engages a protrusion 2248 on the interior passage 2296 of the housing portion 2120 to form a fluid tight seal between the foaming spout 2140 and the housing portion 2120.

A first end of the inlet portion 2110 is configured to be coupled to a tube fluidly coupled to the liquid pump. The first end of the inlet portion 2110 includes an inlet 2112. The inlet 2112 receives the liquid material L from the tube. The first end of the inlet portion 2110 further includes a lip or barbed end 2114 configured to couple the tube to the inlet portion 2110. The tube is slid over the lip 2114 to form a sealed fluid connection with the inlet portion 2110 of the foaming nozzle 2100. The elasticity of the tube may permit the tube to be held in place relative to the inlet portion 2110 without the use of fasteners. However, in some embodiments, a fastener, such as a band or clip, may be used to secure the tube to the inlet portion 2110.

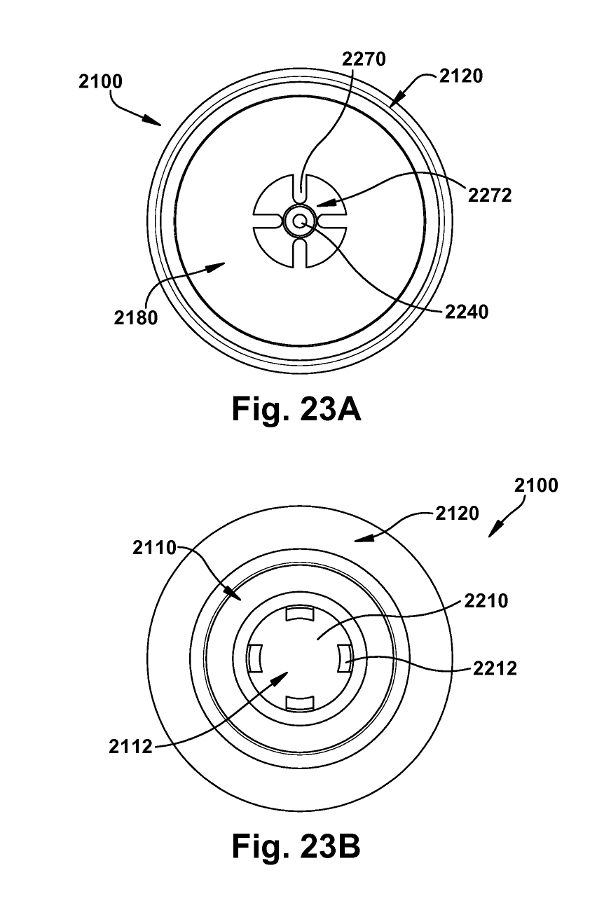

As illustrated in FIG. 22, the inlet portion 2110 of the foaming nozzle 2100 includes an interior passage 2294 along the longitudinal axis 2190 that forms a first portion 2124A of the flow channel 2124 for the liquid material L. A plate 2210 having a plurality of openings 2212 is housed within the first portion 2124A of the flow channel 2124. As illustrated in FIG. 23B, the plate 2210 is circular in shape and the plurality of openings 2212 are disposed about the circumference of the plate.

The valve assembly 2150 includes a valve head 2152, a valve stem 2154, and a biasing member 2156. As shown, the valve assembly 2150 is an umbrella valve moveable between an open position and a closed position (shown in FIG. 22). The valve assembly 2150 is configured such that the valve head 2152 is biased towards the closed position (i.e., normally closed) by the biasing member 2156. In the closed position, the valve head 2152 is pressed against a sealing surface 2220 of the interior passage 2294 to form a fluid tight seal between the valve head and the inlet portion 2110.

The biasing member 2156 of the valve assembly 2150 is configured such that the valve will open when the pressure of the liquid material L in the inlet portion 2110 builds. When this occurs, the biasing member 2156 is compressed and the valve head 2156 is moved away from the sealing surface 2220 of the interior passage 2294 to permit the liquid material L to flow past the valve. For example, as illustrated in FIG. 22, the liquid material L in the first portion 2124A of the flow channel 2124 travels through the openings 2212 in the plate 2210 and into a staging area 2290 formed between the valve head 2220 and the plate. As more liquid material L enters the staging area 2290, the pressure of the liquid material L builds and the valve head 2220 is moved longitudinally away from the sealing surface 2220 breaking the seal between the valve head and the sealing surface. As such, the liquid material L is permitted to escape between the valve head 2220 and the sealing surface 2220 and flow into a second portion 2124B of the flow channel 2124. Further, when the pressure of the liquid material L in the inlet portion 2110 is reduced (e.g., the flow of liquid material from the liquid pump is reduced or shut off), the biasing member 2156 will force the valve head 2156 back to the closed position. As shown, the biasing member 2156 is a spring. However, other configurations of valves and biasing members may be used.

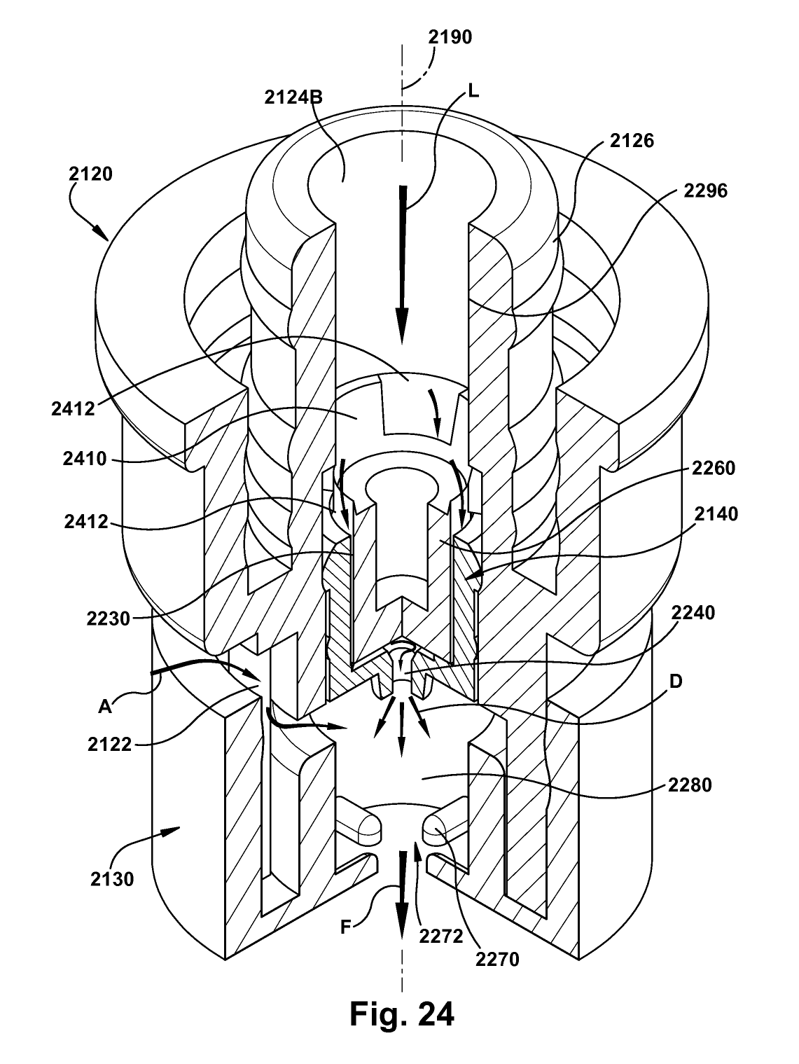

As illustrated in FIGS. 22 and 24, the housing portion 2120 of the foaming nozzle 2100 includes an interior passage 2296 along the longitudinal axis 2190 that forms a second portion 2124B of the flow channel 2124 for the liquid material L. The housing portion 2120 also includes a structure housed within the second portion 2124B of the flow channel 2124 and configured to direct the flow of the liquid material L. As illustrated in FIG. 24, the structure includes a central member 2260 and a plurality of outer members 2410 configured to position the central member within the second portion 2124B of the flow channel 2124. The foaming spout 2140 is positioned between an outer surface of the central member 2260 and the interior passage 2296. A plurality of openings 2412 between the outer members 2410 direct the liquid material L into one or more extrusion passages 2230 between the outer surface of the central member 2260 and an inner surface of the foaming spout 2140. These extrusion passages 2230 are configured to restrict the flow of the liquid material L and increase the velocity of the liquid material. The gap between the outer surface of the central member 2260 and an inner surface of the foaming spout 2140 forms the extrusion passage 2230.

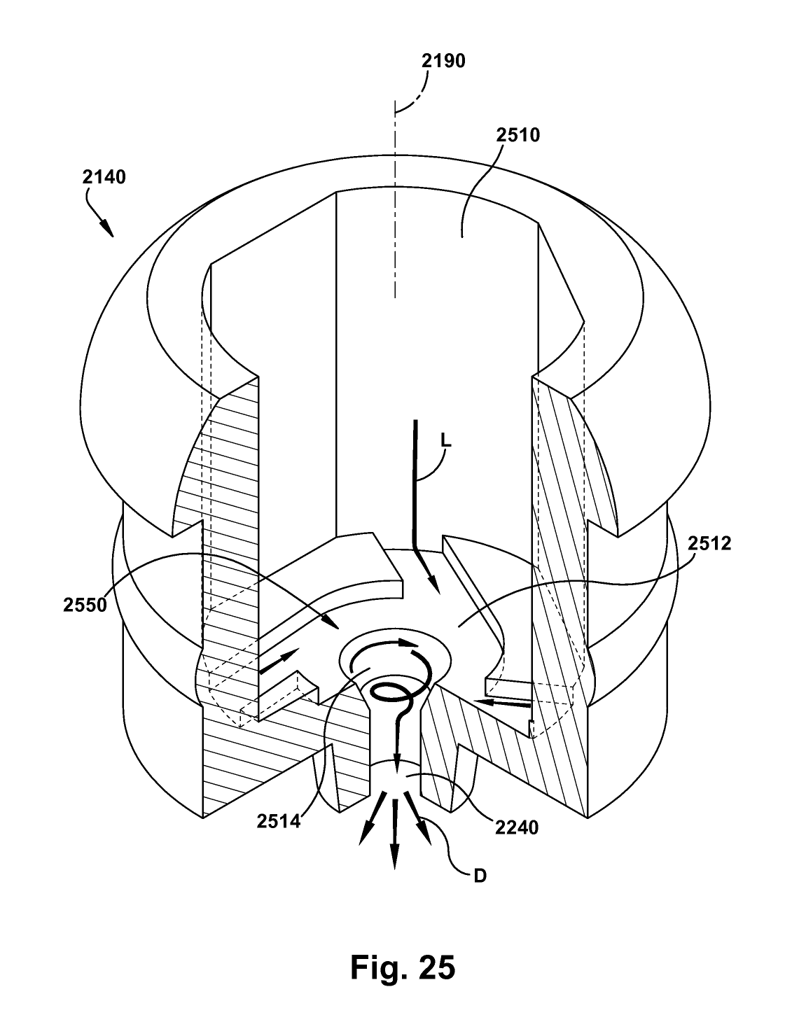

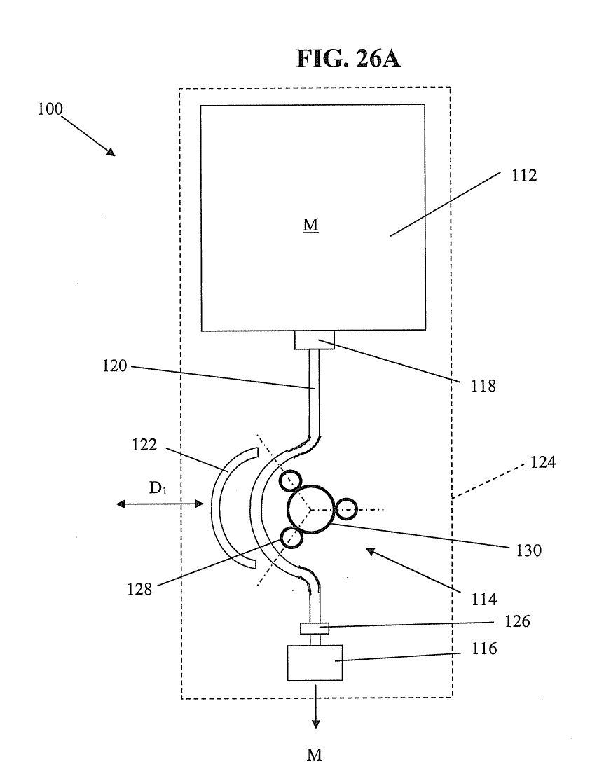

As illustrated in FIG. 25, the foaming spout 2140 of the foaming nozzle 2100 includes a plurality of sidewalls 2510 extending upward from a bottom 2530 and an orifice 2240. Channels 2512 are formed in the bottom 2530 of the foaming spout 2140. The channels 2512 are configured to receive the liquid material L from the extrusion passages 2230 formed between the inner surface of the sidewalls 2510 and the outer surface of the of the central member 2260 (FIG. 24). Further, the channels 2512 are shaped and configured in a swirl pattern to cause the liquid material L to rotate in the bottom 2530 of the foaming spout 2140. In one embodiment, the channels 2512 are tangential to a bowl shaped inlet 2514. The rotating liquid material L continues to rotate about the bowl shaped inlet 2514 of the orifice 2240 formed in the bottom 2530 of the foaming spout 2140. The rotating liquid material L is forced through the orifice 2240. In one embodiment, the extrusion passages 2230 and the foaming spout 2140 are configured to accelerate the liquid material L such that the liquid material exits the orifice 2240 at velocity of about 1 m/s.

As illustrated in FIGS. 22 and 24, the orifice 2240 is shaped and configured as the frustum of a cone. In one embodiment, the outlet of the orifice 2240 has a diameter of about 0.02 inch. As the liquid material L flows through the orifice 2240, an area of low pressure is created at the outlet of the orifice and the liquid material L is broken into small droplets (i.e., the Venturi effect). In this regard, the orifice 2240 acts as an atomizer nozzle to produce a fine spray of liquid material D. The fine spray of liquid material D is delivered into a mixing chamber 2280 of the foaming chip portion 2130.

As illustrated in FIGS. 22, 23A, and 24, the foaming chip portion 2130 includes the mixing chamber 2280, an air passage 2122, a screen 2270, and an outlet 2272. The air passage 2122 is formed between the foaming chip portion 2130 and the housing portion 2120. The area of low pressure formed within the mixing chamber 2280 creates a vacuum that draws in external air A (i.e., the Venturi effect). The air A travels through the air passage 2122 and into the mixing chamber 2280. The air A mixes with the fine spray of liquid material D in the mixing chamber 2280 to form a mixture of liquid material and air. The mixture passes through the screen 2270 to create a foam F that is dispensed out the outlet 2272 of the foaming chip portion 2130. As illustrated in FIG. 23A, the screen 2270 of the foaming chip portion 2130 includes a plurality of members extending radially inward from the circumference of a circular opening. In one exemplary embodiment, the plurality members are shaped and configured such that open area of the screen 2270 is about 80% of the area of the circular opening.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A liquid dispenser for dispensing foam, comprising:
a frame portion;
a pump portion comprising one or more compression members coupled to a rotatable member, the rotatable member configured to rotate relative to the frame portion;
a refill portion comprising a liquid container, a tube, and a foaming nozzle, wherein a first end of the tube is fluidly coupled to the liquid container and a second end of the tube is fluidly coupled to the foaming nozzle; and
a guide portion coupled to the frame portion, wherein at least one of the guide portion and the pump portion are movable between a first position and a second position, wherein in the first position the guide portion is spaced away from at least one compression member of the pump portion to permit the tube to be placed between the guide portion and the compression member, and wherein in the second position the tube is compressed by the at least one compression member as the rotatable member rotates relative to the frame portion to move liquid material from the liquid container to the foaming nozzle; and
wherein the foaming nozzle is configured to convert the liquid material to a foam, and wherein the foam is dispensed by the liquid dispenser.

2. The liquid dispenser of claim 1, wherein the guide portion is fixed relative to the one or more compression members as the compression members move relative to the frame portion.

3. The liquid dispenser of claim 1, wherein the one or more compression members comprise one or more rollers spaced about a circumference of the rotatable member.

4. The liquid dispenser of claim 3, wherein the one or more rollers are configured to rotate relative to the rotatable member in a direction opposite the direction of rotation of the rotatable member.

5. The liquid dispenser of claim 1, wherein the guide portion comprises a locking mechanism for holding the guide portion substantially stationary as the rotatable member rotates relative to the frame portion.

6. The liquid dispenser of claim 1, wherein in the second position at least a portion of the tube is pinched between the guide portion and the at least one compression member of the pump portion.

7. The liquid dispenser of claim 6, wherein the guide portion comprises a biasing member configured to bias the guide portion in a direction toward the second position.

8. The liquid dispenser of claim 6, wherein the pump portion comprises a biasing member configured to bias the pump portion in a direction toward the second position.

9. The liquid dispenser of claim 1, wherein the refill portion is removable from the liquid dispenser without the use of tools.

10. The liquid dispenser of claim 1, wherein the foaming nozzle is configured to convert the liquid material to a mist of liquid material, and wherein the mist is mixed with air within the foaming nozzle to form a mixture, and wherein the mixture is passed through a screen of the foaming nozzle and is dispensed as the foam.

11. The liquid dispenser of claim 1, wherein the foaming nozzle comprises an orifice having a reduced cross sectional area, and wherein the foaming nozzle is configured to force the liquid material through the orifice to form a mist of liquid material.

12. The liquid dispenser of claim 11, wherein the mist of liquid material is mixed with air drawn into the foaming nozzle by a pressure vacuum created by the liquid material passing through the orifice.

13. The liquid dispenser of claim 11, wherein the orifice is an atomizer nozzle.

14. The liquid dispenser of claim 13, wherein the foaming nozzle is configured such that the liquid material rotates within the foaming nozzle before being forced through orifice.

15. The liquid dispenser of claim 1, wherein the pump portion is a peristaltic pump.

16. A refill unit for a foam dispenser, comprising:
a liquid container configured to hold a liquid material;
a tube having a first end and a second end, the first end fluidly coupled to the liquid container; and
a foaming nozzle fluidly coupled to the second end of the tube, wherein the foaming nozzle is configured to convert the liquid material to a mist of liquid material by forcing the liquid material through an orifice having a reduced cross sectional area, and wherein the mist of liquid material is mixed with air drawn into the foaming nozzle by a pressure vacuum created by the liquid material passing through the orifice, and wherein the mixture of the mist of liquid material and air is passed through a screen of the foaming nozzle.

17. The refill unit of claim 16, wherein the foaming nozzle is configured such that the liquid material rotates within the foaming nozzle before being forced through the orifice.

18. A method for replacing a refill unit of a liquid dispenser, comprising
moving at least one of a guide portion and a pump portion of the liquid dispenser relative to a frame portion of the liquid dispenser from a first position to a second position, wherein in the second position a first tube of a first refill unit is removable from between the guide portion and at least one compression member of the pump portion, and wherein the at least one compression member is movable relative to a frame portion of the liquid dispenser;
removing the first tube of the first refill unit from between the guide portion and the at least one compression member;
positioning a second tube of a second refill unit between the guide portion and the at least one compression member;
moving at least one of the guide portion and the pump portion of the liquid dispenser relative to the frame portion of the liquid dispenser from the second position to the first position, wherein in the first position the second tube is compressed by the at least one compression member of the pump portion as the compression member moves relative to the frame portion of the liquid dispenser; and
locking at least one of the guide portion and the pump portion in place relative to the frame portion of the liquid dispenser.

19. The method of claim 18, wherein the pump portion comprises one or more compression members coupled to a rotatable member, the rotatable member configured to rotate relative to a frame portion of the liquid dispenser.

20. The method of claim 19, wherein at least the second refill unit comprises a liquid container and a foaming nozzle fluidly coupled to the second tube, and wherein the second tube is compressed by the one or more compression members as the rotatable member rotates relative to the frame portion to move liquid material from the liquid container to the foaming nozzle, and wherein and the foaming nozzle is configured to convert the liquid material to a foam, and wherein the foam is dispensed by the liquid dispenser.

21. The method of claim 18 further comprising positioning the second tube in a groove of the guide portion.

22. The method of claim 18, wherein the liquid dispenser comprises a biasing member for moving at least one of the guide portion and the pump portion relative to the frame portion of the liquid dispenser.
